(19) United States
(12) Patent Application Publication
(10) Pub. No.: US 2023/0245244 A1
(43) Pub. Date: Aug. 3, 2023

(54) SYSTEM AND METHOD FOR UNDERWRITING BENEFIT SYSTEM COVERAGE APPLICATIONS

(71) Applicant: Tim Donald Johnson, Norwalk, IA (US)

(72) Inventor: Tim Donald Johnson, Norwalk, IA (US)

(21) Appl. No.: 18/103,067

(22) Filed: Jan. 30, 2023

Related U.S. Application Data
(60) Provisional application No. 63/305,328, filed on Feb. 1, 2022.

(51) Int. Cl. G06Q 40/08

(52) U.S. Cl. CPC G06Q 40/08

(57) ABSTRACT

A system is disclosed for underwriting benefit system applications. The system includes a front end system and a back end system communicatively connected to the front end system. The front end system is configured to provide a first user interface for a broker to submit an application for coverage of a group for a plurality of benefit coverage plans selected by the broker. The group includes a plurality of individuals. The back end system is configured to automatically evaluate risk for the plurality of individuals and determine rates for the plurality of benefit coverage plans for the group.

### CROSS REFERENCE TO RELATED APPLICATION

This application is related to U.S. Pat. No. 11,277,497, titled SYSTEM FOR STORING, PROCESSING, AND ACCESSING MEDICAL DATA, and filed Jul. 27, 2020; which claims benefit of provisional application No. 62/879,876 filed on Jul. 29, 2019; the entirety of each of which is hereby fully incorporated by reference herein. This application claims benefit from U.S. Provisional Application No. 63/305,328, titled SYSTEM FOR STORING, PROCESSING, AND ACCESSING MEDICAL DATA, and filed Feb. 1, 2022, the entirety of which is fully incorporated by reference herein.

### FIELD OF THE DISCLOSURE

The disclosure generally relates to systems and methods to facilitate underwriting and management of benefit system policies.

### OVERVIEW OF THE DISCLOSURE

Costs of healthcare in the United States continue to increase and are reaching unsustainable levels. Several healthcare industry analysis point to the fact that this is unsustainable, and something must be done to reverse the trend. Many attempts have indeed been made to rein in costs, however intended results always seem to not follow, or when they do, they are not long lasting. Contributing to high costs are inability to upfront costs efficiently and accurately underwrite medical benefit system coverage applications.

Benefit system underwriting may go through different levels of scrutiny ranging from non-medical basis (or simplified issue) applications, where the applicant and/or broker submit relevant medical information, to applications requiring physical medical examination by a physician. Due to the high cost of examination, medical examinations are only practical when there are a small number of applicants seeking a large amount of coverage. Similarly, the administrative costs to review detailed medical history for simplified issue applications can also be excessively high and unpractical for group plans having a large number of members.

Typically, employer-based medical benefit system coverage is sold to employers as group plans by brokers at specially quoted rates that are offered to all employees of the employer. For employers having a large number of employees, it is not cost effective for an underwriter to review individual medical history for each individual employee. Rather, for such group benefit system plans, carrier typically obtain a minimal set of coarse data metrics on the employees. For example, one large national group plan carrier determines group plan rates based on age, demographic, geographic location, and/or industry of employment (e.g., Standard Industry Classification Code) of the employees in the group. Based on this minimal coarse information, projected medical claims are manually estimated by underwriters of a benefit system carrier and group plan rates are quoted at appropriate levels that exceed the projected medical claims by a threshold profit margin. However, the smaller the amount of data that is evaluated, the less accurate the projected medical claims will be. Accordingly, to mitigate risk of loss, benefit system carriers may set rates higher than would otherwise be necessary, thereby increasing medical cost for group plan employers and their employees and leading to less competitive group plans. Conversely, group plans rates with tighter profit margins may be more competitive but have higher lead to loss when underwriting is performed with a minimal coarse amount of data. Previous processes for sales of benefit system policies requiring manual review by underwriters are also inefficient and time consuming.

Therefore, for all the reasons stated above, and the reasons stated below, there is a need in the art to improve processes and system for underwriting benefit system coverage policies. It is an object of the disclosure to provide a system to facilitate submission and/or underwriting of benefit system coverage policies.

Another object of the disclosure is to provide a system for submission and/or underwriting of benefit system coverage policies that is efficient

Yet another object of the disclosure is to provide a system for submission and/or underwriting of benefit system coverage policies that is cost effective

Another object of the disclosure is to provide a system for submission and/or underwriting of benefit system coverage policies that utilizes more detailed medical data to provide improved accuracy.

Yet another object of the disclosure is to provide a system for submission and/or underwriting of benefit system coverage policies that identifies high risk individuals for more detailed assessment.

Another object of the disclosure is to provide a system for submission and/or underwriting of benefit system coverage policies that is automated.

Yet another object of the disclosure is to provide a system for submission and/or underwriting of benefit system coverage policies that is scalable.

Another object of the disclosure is to provide a system for submission and/or underwriting of benefit system coverage policies that can be used for large and small group policies.
Yet another object of the disclosure is to provide a system for submission and/or underwriting of benefit system coverage policies that saves time.
Another object of the disclosure is to provide a system for submission and/or underwriting of benefit system coverage policies that is easy and intuitive to use.

Yet another object of the disclosure is to provide a system for submission and/or underwriting of benefit system coverage policies that improves a user experience.

These and other objects, features, or advantages of the disclosure will become apparent from the specification, figures, and claims.

### BRIEF DESCRIPTION OF THE DRAWINGS

FIG. 1 shows a system for submission and underwriting of benefit system applications, in accordance with one or more arrangements.

FIG. 2 shows a system for submission and underwriting of benefit system applications, in accordance with one or more arrangements.

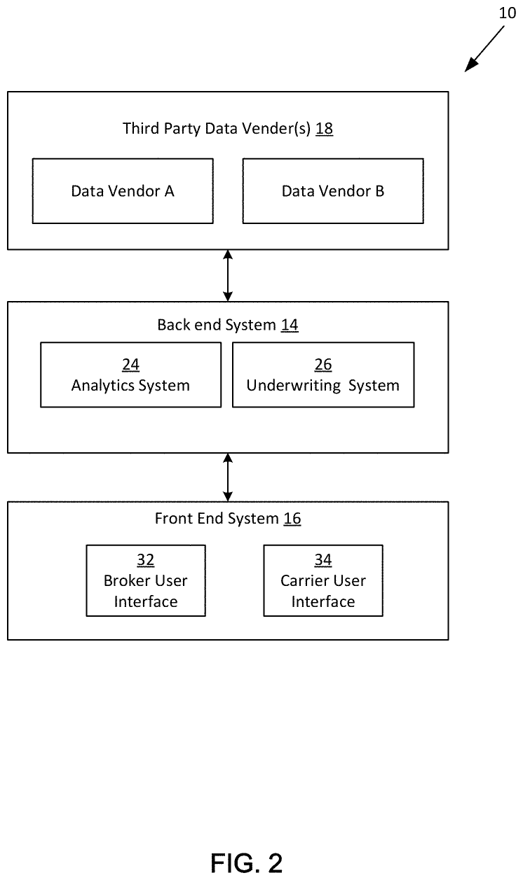

FIG. 3 shows a system for submission and underwriting of benefit system applications, in accordance with one or more arrangements.

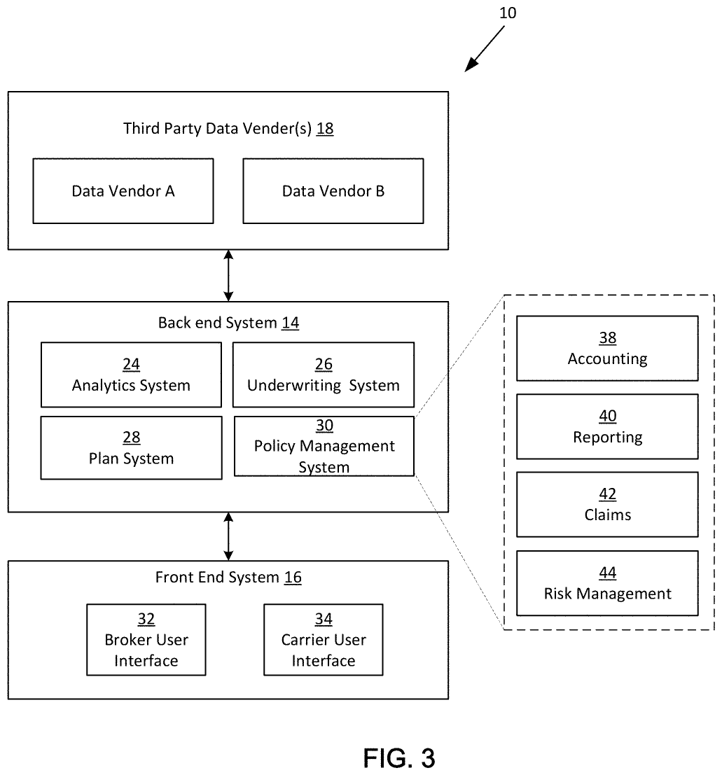

FIG. 4 shows a system for submission and underwriting of benefit system applications, in accordance with one or more arrangements.

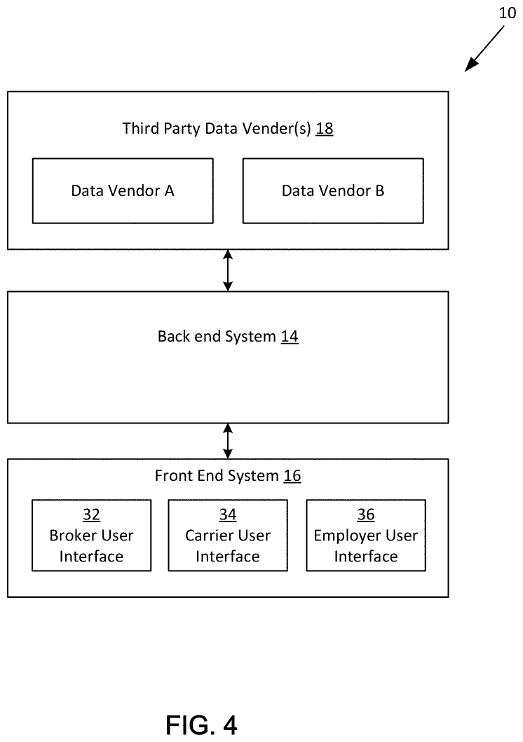

FIG. 5 shows a flow chart of an example process for processing applications and generating quotes for group benefit system coverage, in accordance with one or more arrangements.

FIG. 6 shows a flow chart of an example process for processing applications and generating quotes for group benefit system coverage, in accordance with one or more arrangements.

FIG. 7 shows a flow chart of an example process for automatic determination of rates for benefit system coverage plans by scaling a base rate according to a respective modifier for each plan, in accordance with one or more arrangements.

FIG. 8 shows a flow chart of an example process for underwriting applications using carrier specific criteria and generating quotes for group benefit system coverage, in accordance with one or more arrangements.

FIG. 9 shows a flow chart of an example process for configuration of benefit system coverage plans by a carrier, in accordance with one or more arrangements.

FIG. 10 shows a screenshot of an example dashboard type interface for a broker user interface 32 to facilitate easy access and review of applications for group benefit system coverage, in accordance with one or more arrangements.

FIG. 11 shows a screenshot of the example dashboard type interface shown in FIG. 10 with an interface window facilitate creation of a new group and prospective application for group benefit system coverage, in accordance with one or more arrangements.

FIG. 12 shows a screenshot of the example dashboard type interface shown in FIG. 10 with an interface window configured to facilitate creation of a new group and prospective application for group benefit system coverage, in accordance with one or more arrangements.

FIG. 13 shows a screenshot of an example broker user interface to facilitate review and management of applications for benefit system coverage at various stages of the application, in accordance with one or more arrangements; the view showing an application in a census stage.

FIG. 14 shows a screenshot of the example broker user interface shown in FIG. 13 with an interface window configured to facilitate import of census data for a group, in accordance with one or more arrangements.

FIG. 15 shows a screenshot of the example broker user interface shown in FIG. 13, in accordance with one or more arrangements; the view showing an application in a configuration stage, in accordance with one or more arrangements; the view showing a Members tab selected to facilitate selection and viewing/editing information for current members of the group.

FIG. 16 shows a screenshot of the example broker user interface shown in FIG. 13, in accordance with one or more arrangements; the view showing an application in a configuration stage, in accordance with one or more arrangements; the view showing a HealthApps Needed tab selected to facilitate review of members of the group from which additional information is required.

FIG. 17 shows a screenshot of the example broker user interface shown in FIG. 13, in accordance with one or more arrangements; the view showing an application in a configuration stage, in accordance with one or more arrangements; the view showing a Quotes tab selected to facilitate creation, review, and/or editing of quotes for the group.

FIG. 18 shows a screenshot of the example broker user interface shown in FIG. 17 with an interface window configured to facilitate creation of a new quote, in accordance with one or more arrangements.

FIG. 19 shows a screenshot of the example broker user interface shown in FIG. 17 with an interface window configured to facilitate creation of a new quote, in accordance with one or more arrangements.

FIG. 20 shows a screenshot of the example broker user interface shown in FIG. 17 with an interface window configured to facilitate creation of a new quote, in accordance with one or more arrangements.

FIG. 21 shows a screenshot of the example broker user interface shown in FIG. 17 with an interface window showing an example quote created using the broker user interface, in accordance with one or more arrangements; the view showing a plan result tab of the interface window selected.

FIG. 22 shows a screenshot of the example broker user interface shown in FIG. 17 with an interface window showing an example quote created using the broker user interface, in accordance with one or more arrangements; the view showing a surplus option tab of the interface window selected.

FIG. 23 shows a screenshot of the example broker user interface shown in FIG. 17 with an interface window showing an example quote created using the broker user interface, in accordance with one or more arrangements; the view showing a census tab of the interface window selected.

FIG. 24 shows a screenshot of the example broker user interface shown in FIG. 17 with an interface window showing an example quote created using the broker user interface, in accordance with one or more arrangements; the view showing a NHA members tab of the interface window selected.

FIG. 25 shows an example dashboard type interface for a broker user interface 34 to facilitate easy access and review of applications for group benefit system coverage, in accordance with one or more arrangements.

FIG. 26 shows a screenshot of the example carrier user interface for review and configure of an application after a quote has been created, in accordance with one or more arrangements; the view showing a Members tab selected to facilitate selection and viewing/editing of information for current members of the group.

FIG. 27 shows a screenshot of the example carrier user interface shown in FIG. 26, in accordance with one or more arrangements; the view showing a HealthApps Needed tab selected to facilitate review of members of the group from which additional information is required.

FIG. 28 shows a screenshot of the example carrier user interface shown in FIG. 27 with an interface window to facilitate underwriting of a selected member of a group, in accordance with one or more arrangements; the view showing a medical conditions tab of the interface window selected.

FIG. 29 shows a screenshot of the example carrier user interface shown in FIG. 27 with an interface window to facilitate underwriting of a selected member of a group, in accordance with one or more arrangements; the view showing a medical conditions tab of the interface window selected; the view showing a second interface window to facilitate entry of medical conditions for a member.

FIG. 30 shows a screenshot of the example carrier user interface and interface windows shown in FIG. 29, in accordance with one or more arrangements.

FIG. 31 shows a screenshot of the example carrier user interface and interface window shown in FIG. 29, in accordance with one or more arrangements; the view showing an underwriting history tab of the interface window selected.

FIG. 32 shows a screenshot v and interface window shown in FIG. 31, in accordance with one or more arrangements; the view showing an interface window detailing a selected underwriting event.

FIG. 33 shows a screenshot of an example interface window of the example carrier user interface that may be presented to facilitate approval of a health application for an individual of a group, in accordance with one or more arrangements.

FIG. 34 shows a screenshot of an example interface window of the example carrier user interface that may be presented after approval of a health application to prompt a user to resubmit one or more quotes that may have been affected, in accordance with one or more arrangements.

FIG. 35 shows a screenshot of an example broker user interface updated following approval of health apps for all group members of a quote, in accordance with one or more arrangements.

FIG. 36 shows a screenshot of the example broker user interface shown in FIG. 35 with an interface window configured to facilitate purchase of a finalized quotation, in accordance with one or more arrangements.

FIG. 37 shows another screenshot of the example broker user interface and interface window shown in FIG. 36, in accordance with one or more arrangements.

FIG. 38 shows another screenshot of the example broker user interface and interface window shown in FIG. 36, in accordance with one or more arrangements.

FIG. 39 shows another screenshot of the example broker user interface and interface window shown in FIG. 36, in accordance with one or more arrangements.

FIG. 40 shows a screenshot of the example broker user interface shown in FIG. 35, in accordance with one or more arrangements; the view showing the application moved to a commitment stage.

FIG. 41 shows a screenshot of the example broker user interface shown in FIG. 35, in accordance with one or more arrangements; the view showing the application moved to an enrolment stage.

FIG. 42 shows a screenshot of the example broker user interface shown in FIG. 41 with an interface window for enrolment of a group member, in accordance with one or more arrangements.

FIG. 43 shows a screenshot of the example broker user interface shown in FIG. 35 with an interface window for conformation before moving an application to an implementation stage, in accordance with one or more arrangements.

FIG. 44 shows a screenshot of the example broker user interface shown in FIG. 35, in accordance with one or more arrangements; the view showing the application moved to an implementation stage.

FIG. 45 shows a diagram of a data processing system that may be configured to implement one or more various operations and activities described herein, in accordance with one or more arrangements.

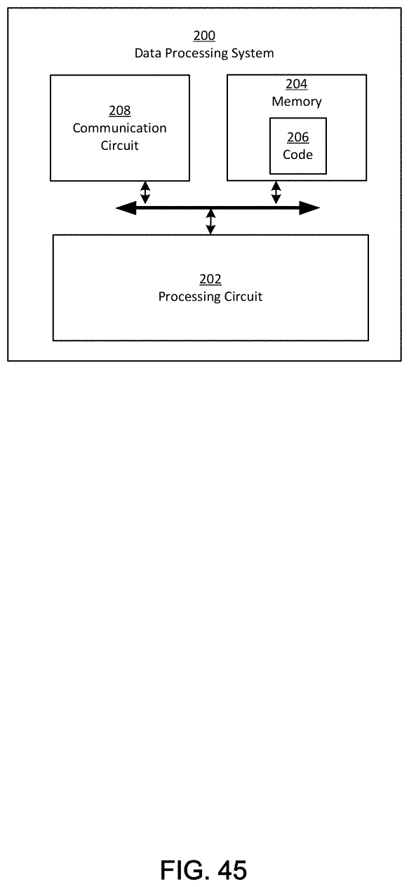

### SUMMARY OF THE DISCLOSURE

A system is disclosed for underwriting benefit system applications. The system includes a front end system and a back end system communicatively connected to the front end system. The front end system is configured to provide a first user interface for a broker to submit an application for coverage of a group for a plurality of benefit coverage plans selected by the broker. The group includes a plurality of individuals. The back end system is configured to automatically evaluate risk for the plurality of individuals and determine rates for the plurality of benefit coverage plans for the group.

In one or more arrangements, the back end system is configured to automatically evaluate risk for the plurality of individuals and determine rates for the plurality of benefit coverage plans for the group by: determining a base rate for a first one of the plurality of benefit coverage plans; retrieving a modifier for a second one of the plurality of benefit coverage plans; and determining a rate for the second one of the plurality of benefit coverage plans by multiplying the base rate by the modifier.

In one or more arrangements, the back end system is configured to store respective sets of carrier specific underwriting criteria for the plurality of carriers. The back end system is further configured to identify which carrier of the plurality of carriers offers the one or more benefit coverage plans and retrieve the respective set of carrier specific underwriting criteria for the identified carrier. The back end system is configured to automatically evaluate risk for the plurality of individuals and determine rates for the one or more benefit coverage plans for the group according to the carrier specific underwriting criteria for the identified carrier.

In one or more arrangements, the back end system is configured to retrieve and/or derive supplemental data on the plurality of individuals. The back end system is configured to user the supplemental data in evaluating the risk for the plurality of individuals and determining rates for the one or more benefit coverage plans for the group

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of underwriting medical benefit system coverage. However, the embodiments are not so limited. It is appreciated that the embodiments may be adapted for use in other applications which may be improved by the disclosed structures, arrangements and/or methods. The system is merely shown and described as being used in the context of medical benefit system coverage for ease of description and as one of countless examples.

### System 10

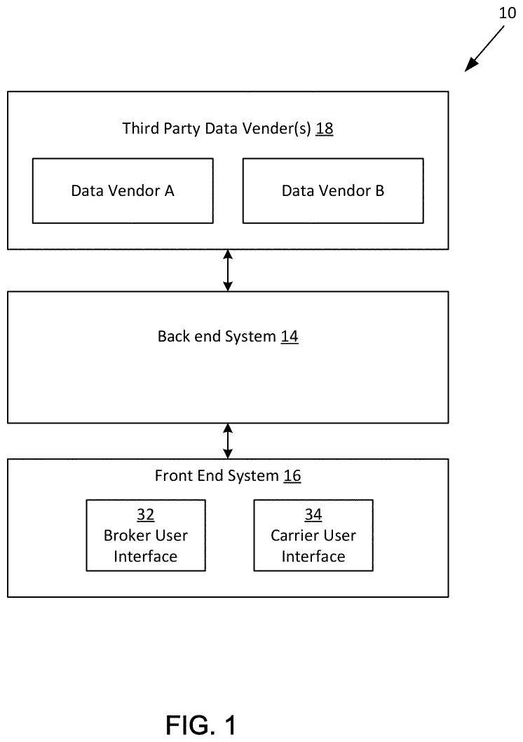

With reference to the figures, a system for submission and/or underwriting of group benefit system coverage plans 10 (or simply system 10) is presented. The system 10 is formed of any suitable design, arrangement, and circuitry and is configured to facilitate underwriting of group benefit system coverage plans. In one or more arrangements, as shown in FIG. 1 for example, the system 10 includes a front end system 16 and a back end system 14 among other components. Front end system 16 and back end system 14 are communicatively connected over one or more data networks.

### Back End System 14

Back end system 14 is formed of any suitable size, shape, design, and/or technology and is configured to perform one or more functions to facilitate underwriting of group medical benefit system coverage policies. In the arrangement shown, as one example, back end system 14 includes an analytics system 24 and an underwriting system 26, among other components.

Analytics System 24:

In one or more arrangements, back end system 14 includes an analytics system 24. Analytics system 24 is formed of any suitable size, shape, design, and/or technology and is configured to derive and/or retrieve additional data metrics on prospective applicants for a requested group plan quotation. In the arrangement shown, as one example, analytics system 24 is configured to retrieve additional medical data for prospective applicants from one or more third party data vendors 18. In some arrangements, analytics system 24 is configured to communicate with one or more of the third party data vendors 18 using respective application program interfaces (APIs). However, the arrangements are not so limited. Rather, it is contemplated that in some various arrangements, analytics system 24 is configured to communicate with third part suppliers using various means and methods including but not limited to, for example, data vendor provided APIs, custom APIs, SQL queries, file downloads (e.g., catalogs, data sheets, etc.), scraping of websites, automated submission of inquiries for data (e.g., via email, fax, FTP, Dropbox, and/or any other means or methods for retrieval of data.

In one or more arrangements, third party data vendors 18 may include a data vendor that provides anonymized data indicating medications and conditions of the group. Additionally or alternatively, in one or more arrangements, third party data vendors 18 may include a data vendor that provides a listing of the prospective applicants in the group that are higher risk without disclosing medical information on such applicants. However, the arrangements are not so limited. Rather, it is contemplated that in one or more arrangements, analytics system 24 may be configured to retrieve data from data sources that provide various other data metrics. Moreover, it is contemplated that in one or more arrangements, back end system 14 may be configured to additionally or alternatively retrieve information from a local database (optional) of back end system 14. Additionally or alternatively, in one or more arrangements, back end system 24 may be configured to perform various analytics processes to derive additional information relevant to underwriting of benefit system coverage policies for prospective applicants.

It is recognized that medical data that may be obtained from data vendors may be limited due to restrictions on disclosure of medical information. In one or more arrangements, analytics system 24 is configured to combine and perform data analytics on data from multiple data sources to derive additional data metrics relevant to underwriting of benefit system coverage policies for the prospective applicants. For example, in one or more arrangements, analytics system 24 may be configured to cross correlate anonymized medical data and/or non-medical data from multiple data sources to estimate a number of employees with identified high risk conditions. Using such data, projected medical claims may be estimated with better accuracy. In the arrangement shown, analytics system 24 is configured to provide retrieved/derived data for prospective applicants in the group to underwriting system 26.

Underwriting System 26:

In one or more arrangements, back end system 14 includes an underwriting system 26. Underwriting system 26 is formed of any suitable size, shape, design, and/or technology and is configured to perform various operations, such as estimating projected medical claims and/or determining risk of prospective applicants for a new group plan to facilitate underwriting and/or quotation of group benefit coverage plans.

Automated Underwriting Processes:

In one or more arrangements, underwriting system 26 is configured to automatically receive/retrieve additional data metrics for the prospective application from the analytics system 24 and estimate projected claims for the group using the data received with the application supplemented with the data received from the analytics system 24. In one or more arrangements, provided by analytics system 24 may include but is not limited to, for example, supplemental demographic information of applicants (e.g., age, sex, demographic, geographic location, industry of employment), identified conditions and/or prescriptions of group, a subset of high risk individuals in group, and/or any other relevant information. Additionally or alternatively, in one or more arrangements, analytics system 24 may provide underwriting system 26 an initial risk assessment of group individual (e.g., provided be a third party data vendor 18).

Additionally or alternatively, in one or more arrangements, underwriting system 26 is configured to perform various automated actions to facilitate underwriting of group benefit coverage plans. For example, in one or more arrangements, underwriting system 26 may apply a set of criteria to identify high risk individuals of a group and cause system 10, broker, and/or third party system to prompt the identified individuals to provide additional medical information (e.g., by submitting a more detailed benefit coverage application). Once such additional details are provided, a more accurate estimation of projected claims costs for such high risk individuals and for the group as a whole may be determined. In one or more arrangements, such additional information may be requested from identified individuals by the broker or in an automated fashion (e.g., email), so as to avoid significant administrative cost to the carrier.

In one or more arrangements, underwriting system 26 is configured to automatically evaluate the information of group individuals that is received to evaluate/reevaluate risk for the group individuals. Additionally or alternatively, in one or more arrangements, underwriting system 26 may prompt system 10 to have the supplemented information for high risk individuals reviewed by a professional underwriter. Additionally or alternatively, in one or more arrangements, underwriting system 26 may apply a set of criteria to identify individuals of a group for manual review by a professional underwriter. Such criteria may identify individuals by various demographics including but not limited to, for example, age, sex, demographic, geographic location, industry of employment, identified conditions and/or prescriptions, risk assessment of individuals, and/or any other relevant information.

Automated Adjustment of Risk Assessments:

Additionally or alternatively, in some various arrangements, underwriting system 26 may apply a set of criteria to automatically adjust risk assessments for individuals/groups initially determined by or system 10 or third party system based on various factors. For example, in one or more arrangements, underwriting system 26 may be configured to increase/decrease risk assessments of individuals to limit the effect outliers may have on assessment of the overall group. For instance, in one or more arrangements, underwriting system 26 may be configured to increase risk assessments of individuals so no individual has a risk falling below a minimum risk level specified by the set of criteria. Conversely, in one or more arrangements, underwriting system 26 may be configured to decrease risk assessments of individuals so no individual has a risk falling exceeding a maximum risk level specified by the set of criteria. However, the arrangements are not so limited. Rather, it is contemplated that in some various arrangements, underwriting system 26 may be configured to adjust risk assessments using various other methodologies and/or functions.

In some various arrangements, criteria used by underwriting system 26 to identify individuals and/or trigger various automated processes may be based on various data metrics, which may include but are not limited to, for example, age, sex, demographic, geographic location, industry of employment, identified conditions and/or prescriptions of group, number of high risk individuals in group, size of group, selected plan options, risk assessment of individuals and/or group, and/or any other relevant factor.

Automated Plan Quotations:

In one or more arrangements, underwriting system 26 may be configured to automatically determine pricing of the selected plans as a function of assessed risks for individuals of the group. For example, in one or more arrangements, underwriting system 26 may determine pricing for a group benefit coverage plan by inputting a quantified group risk into a function or lookup table specified for the plan.

Price-Scaled Plan Tiers:

Traditionally, tiered plans needed to be individually assessed (e.g., by an underwriter) to determine an appropriate price quotation for each tier due to the complex differences between different tiers/plans. In one or more arrangements, back end system 14 maintains a respective modifier for each available tier and/or plan that quantifies costs for the plan relative to a default base plan. This arrangement allows underwriting system 26 to determine a quoted base rate for the base plan based on assessed risk for the group and then quickly determine quotes for a number of additional tiers/plans by scaling the base rate with the corresponding modifier for the plan. In this manner, quotes for multiple different tiers/plans may quickly and efficiently be generated for group benefit coverage plans.

Carrier-Specific Underwriting Criteria:

In one or more arrangements, underwriting system 26 may be configured to perform actions to facilitate quotation and underwriting of plans for a plurality of different carriers of benefit coverage plans according to respective sets of carrier-specific criteria for each carrier.

In one or more arrangements, front end system 16 may provide an interface for carriers to configure criteria and automated actions to be performed in response to such criteria being satisfied. For example, in one or more arrangements, front end system 16 may provide an interface for a carrier to specify one or more rules to direct how underwriting should be processed for various selected plans of the carrier. In one or more arrangements, such rules may be specified as trigger conditions and actions to be performed when such trigger conditions are satisfied (e.g., requiring additional information from or professional underwriting for an individual of a group). Trigger conditions may include, for example, Boolean sensor states, various Boolean functions based on data values (e.g., threshold value triggers), and/or Boolean logic functions of a combination of Boolean sensor states and/or Boolean functions. However, embodiments are not so limited. Rather, it is contemplated that in some various embodiments, trigger conditions may be specified in any configuration, arrangement, format, or structure.

In one or more arrangements, such rules may be stored in a respective configuration data file for the carrier and/or specific plan of carrier. When processing a new group benefit coverage plan application, underwriting system 26 retrieves rules for the applicable plans/carrier from the corresponding configuration data file and performs underwriting processes as directed by the rules specified therein. In this manner, carriers may customize the system 10 to fit their particular underwriting needs.

In Operation

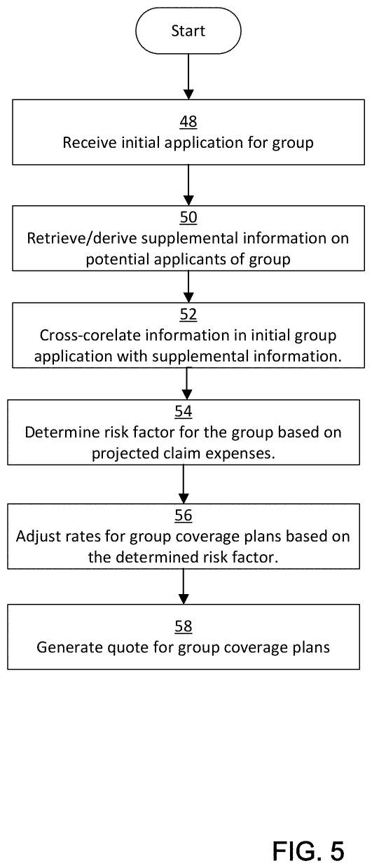

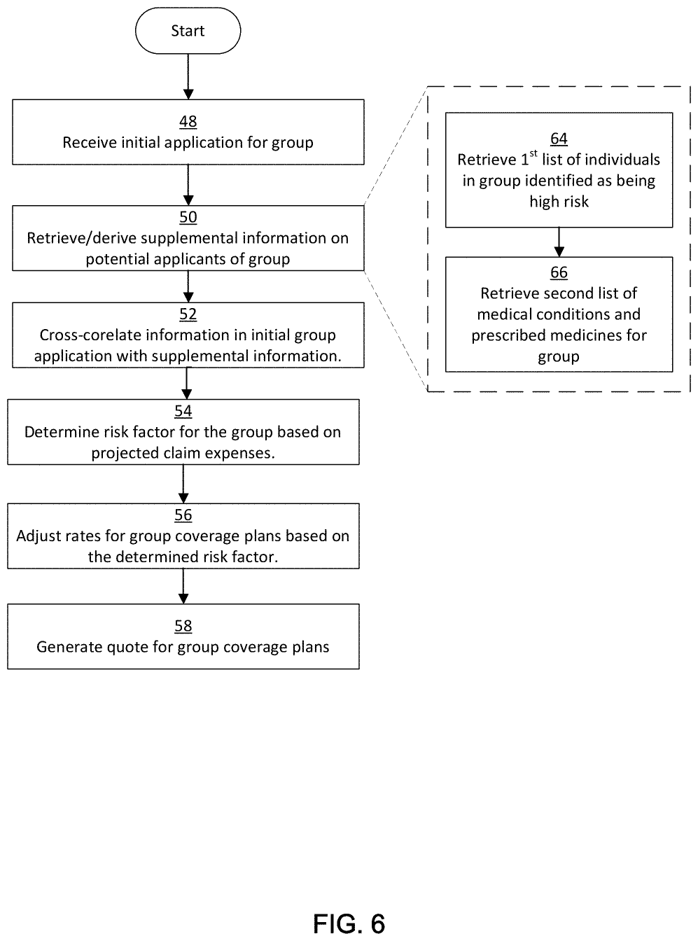

As an illustrative example, FIGS. 5 and 6 show flowcharts of some example processes for processing an application for benefit system coverage using supplemental data for individuals of the group, in accordance with one or more arrangements. In this example, an initial application for benefit system coverage for a group is received by back end system 14 at process block 48. In this example, at process block 50, supplemental information on potential applicants of the group is retrieved and/or derived (e.g., by analytics system 24). As described herein, such supplemental information may include various data metrics and/or info relating to individuals of the group. Due to the sensitive nature of medical information, the scope of information retrieved from any one data vendor may be limited. For example, information may be aggregated and/or anonymized to ensure that medical information of any particular individual cannot be identified. In some arrangements, system may be configured to retrieve different information from multiple data vendors 18 to better assess risk of the group. For example, in the example process shown in FIG. 6, a first list of individuals of the group identified as being high risk but not including any specific medical data is retrieved from a first data vendor at process block 64. At process block 66, a second anonymized list of medical conditions and/or prescription of the group is retrieved from a second data vendor 18. By retrieving supplemental information from multiple data vendors, a more accurate representation of the group may be acquired while complying with applicable restrictions on the transfer of medical information. At process block 52, the supplemental information is cross correlated with information in the initial group application. At process block 54, the supplemented group application information is used to determine a risk factor for the group based on projected claim expenses. At process block 56, rates for benefit system plan coverage for the group is determined based on the determined risk factor for the group. At process block 58, a quote for benefit system plan coverage for the group with the determined rates is generated.

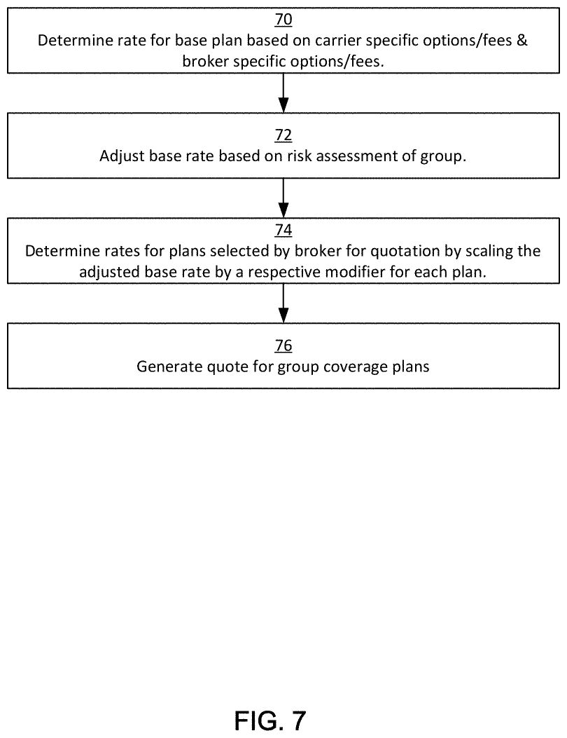

FIG. 7 shows a flowchart for an example process for automatic adjustment of plan rates and generation of quotes, in accordance with one or more arrangements. In this example, at process block 70 the base rate for a base plan is determined having carrier specified options/fees and broker selected options/fees. At process block 72, the determined base rate is adjusted based on risk assessment of the group. At process block 74, rate for plans selected by the broker for quotation are determined by scaling the adjusted base rate by respective modifier(s) for the plan(s). At process block 76, a quote for a benefit system coverage plan for the group is generated with the determined plan rates.

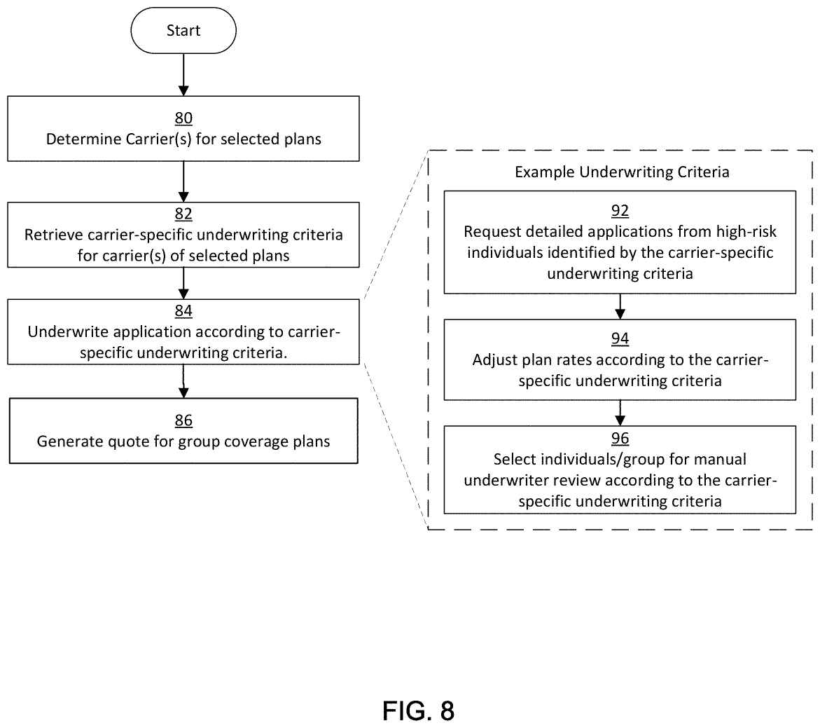

FIG. 8 shows a flowchart for an example process for generation of quotes for group benefit system using carrier specific underwriting criteria, in accordance with one or more arrangements. At process block 80, carriers for the selected plans are determined. At process block 82, carrier-specific underwriting criteria is retrieved for the carriers of the selected plans. At process block 84, the application for group benefit system coverage is underwritten according to the retrieved carrier-specific underwriting criteria.

As an illustrative example, an example process for underwriting using carrier-specific underwriting criteria is shown in process blocks 92-96. At process block 92, detailed applications are requested from high-risk individuals identified using the carrier-specific underwriting criteria. At process block 94, plan rates determined for assessed risk of the group/individuals are adjusted adding to the carrier-specific underwriting criteria as described herein. In this example, at process block 96, individuals/groups are selected, according to the carrier-specific underwriting criteria, for manual review by an underwriter. In this example, following carrier-specific underwriting, a quote for benefit system coverage plans for the group is generated with the determined plan rates at process block 86.

Plan Configuration System 28:

In one or more arrangements, back end system 14 includes a plan configuration system 28. Plan configuration system 28 is formed of any suitable size, shape, design, and/or technology and is configured to permit a carrier to customize plans, applications, underwriting processes, and/or other aspects of offered benefit system coverage. In one or more arrangements, plan configuration system 28 is configured to communicate front end system 16 to permit a carrier to interact with broker user interface 34 to select, create, and/or configure plans to be offered by carrier through system 10. For example, in one or more arrangements, plan configuration system 28 and broker user interface 34 may permit a carrier to specify plan coverages and limits, deductibles, out of pocket limits, coverage exclusions, provider networks, plan base cost and/or risk adjustments, and/or any other information relevant to benefit coverage plans. Additionally or alternatively, in some various arrangements, plan configuration system 28 and broker user interface 34 may permit a carrier to specify carrier-specific underwriting criteria for plans of the carrier. In some arrangements, plan configuration system 28 and broker user interface 34 may permit a carrier to specify respective sets for underwriting criteria for each plan. In this manner, a carrier may customize system 10 to operate as desired by carrier.

Price-Scaled Plan Options:

In one or more arrangements, system 10 is configured to permit carrier to select various options for different plan tiers and automatically adjust default base plan rates/risk assessment accordingly. For example, in one or more arrangements, system 10 maintains maintain default cost for each plan based on Medicare reimbursement rates. In one or more arrangements, system 10 maintains a modifier for each provider network that quantifies medical charges for the provider network relative to Medicare. Upon a carrier selecting a provider network for a plan, system 10 can easily and quickly adjust base plan rate for the network by applying the applicable modifier for the network to the base plan rate. In this manner, a carrier may easily create customized plans without requiring manual assessment to determine risk/cost. However, the arrangements are not so limited. Rather, it is contemplated that in one or more arrangements, system 10 may be configured to automatically adjust plan rates for various different options scaled relative to a default setting by applying an appropriate modifier. Such options may include but are not limited to, for example, selection of provider networks and selection of third party administrators among other options.

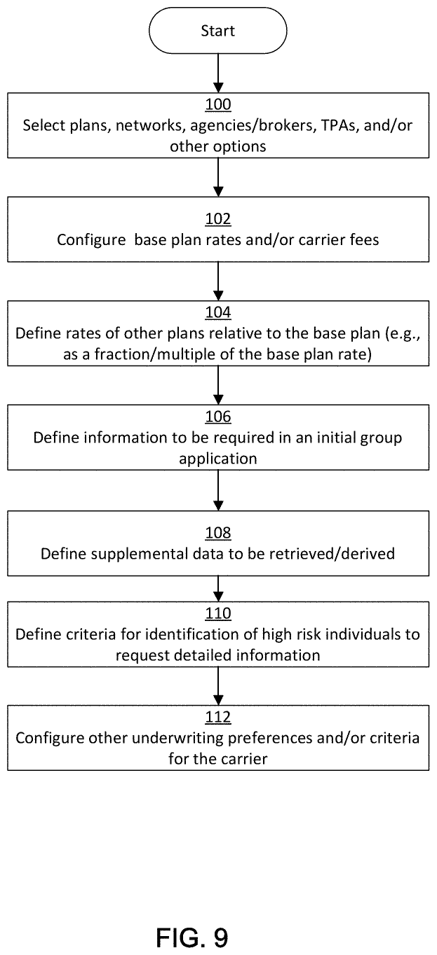

FIG. 9 shows a flowchart for an example process for configuration of plans and options by a carrier, in accordance with one or more arrangements. In this example arrangement, at process block 100, carrier selects and/or configures plans, networks, agencies/brokers, third party administrator (TPA), and/or other applicable options for benefit coverage offered by the carrier. At process block 102, the carrier configures rates for a base plan and applicable carrier fees. At process block 104, the carrier configures rates for other group benefit system plans relative to the base plan rate (e.g., as a fraction/multiple of the base plan rate). At process block 106, the carrier defines information to be provided in an initial application for group benefit system coverage. At process block 108, supplemental data to be retrieved/derived (e.g., by analytics system 24) is specified. At block 110, criteria is defined for identification of high risk individuals from which detailed information should be requested. At process block 112, other underwriting preferences and/or criteria for the carrier is specified.

Policy Management System 30:

In one or more arrangements, back end system 14 includes a policy management system 30. Policy management system 30 is formed of any suitable size, shape, design, and/or technology and is configured to facilitate tracking and management of data and/transactions for pending policies. Such data and/or statistics may include but is not limited to, for example, submitted claims, premiums due/received, expenses and/or fees due/paid, claim coverage period, claim reporting period, policy risk assessment, and/or any other relevant information.

In one or more arrangements, as one example, policy management system 30 implements a number of processes in support of policy management. In the arrangement shown, as one example, policy management system 30 is configured to implement processes for accounting 38, reporting 40, claims processing 42, and risk management 44 of polices. In some various arrangements, account process 38 may track and manage active various data for active benefit system policies including but not limited to, for example, premiums and/or other receivables due/received from covered individuals and/or employers, fees and other expenses payable/paid to carrier, broker, agency, third party administrators and/or other third parties. In some various arrangements, reporting process 40 may automatically generate relevant reports pertinent to pending policies for individuals, employers, carriers, brokers, and/or other parties. Reports may include but are not limited to, for example, monthly statement, benefit summary statements, claims and expense statements, and/or any other relevant documents. In some various arrangements, processes for claims processing 42 may coordinate with the applicable third party administrator, providers, and healthcare professionals tasked with review of claims to coordinate approvals, payment, and tracking of claims. In some various arrangements, processes for risk management 44 may track and evaluate diagnoses and prescriptions of claims to reevaluate projected claims and better assess potential risk over the life cycle of a policy. However, the policy management system 30 is not limited to the example processes described herein. Rather, it is contemplated that in some various arrangements, policy management system 30 may be configured to perform various additional or alternative processes that may be useful to the management of benefit system policies.

### Front End System 16

In one or more arrangements, system 10 includes a front end system 16. Front end system 16 is formed of any suitable size, shape, design, and/or technology and is configured to provide one or more user interfaces for end users to communicate and interact with back end system 14 to facilitate input, access to, and processing of data stored therein and/or perform various operations related to application for and/or underwriting of benefit system coverage.

In one or more arrangements, system 10 includes multiple user interfaces for use by the different types of end-users. In some various different arrangements shown, front end systems 16 includes a broker user interface 32 and a broker user interface 32. However, the arrangements are not so limited to the user interfaces described herein. Rather, it is contemplated that in some various arrangements, system 10 may include any number of user interfaces configured for access by various categories of end users. For example, in one or more arrangements, front end system 16 may be configured to additionally or alternatively provide an employer user interface 36 to facilitate direct application by an employer for benefit system coverage.

User Interfaces:

Broker user interface 32 provided by front end system 16 may be formed of any suitable size, shape, and design, and/or technology and is configured to permit broker end users to interact with back end system 14 to facilitate input, access to, and processing of relevant data to facilitate application for and/or underwriting of benefit system coverage.

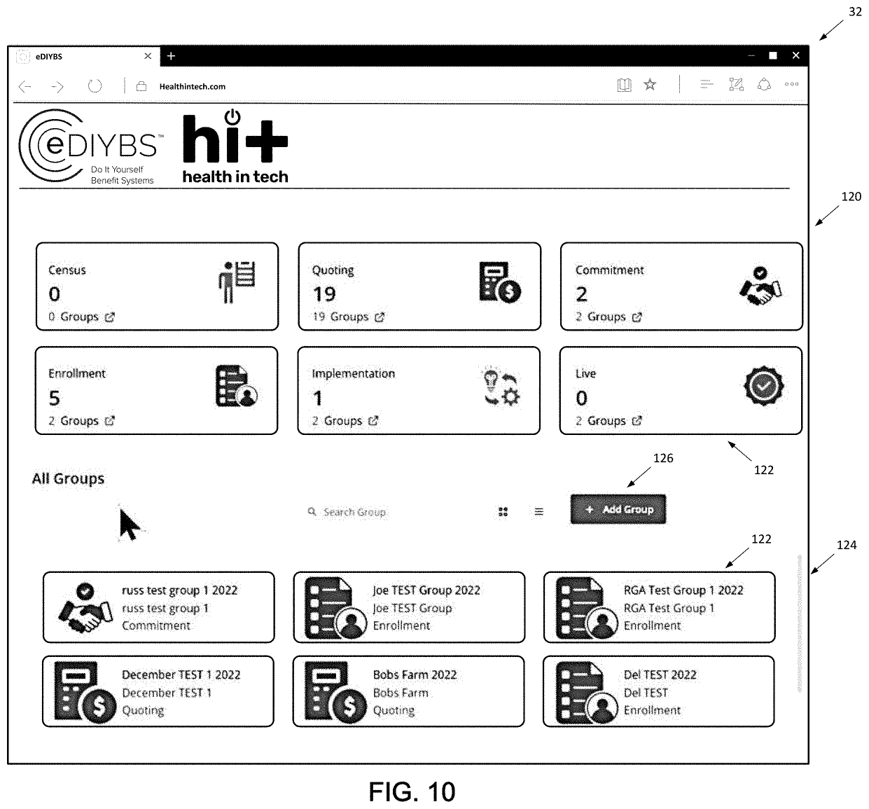

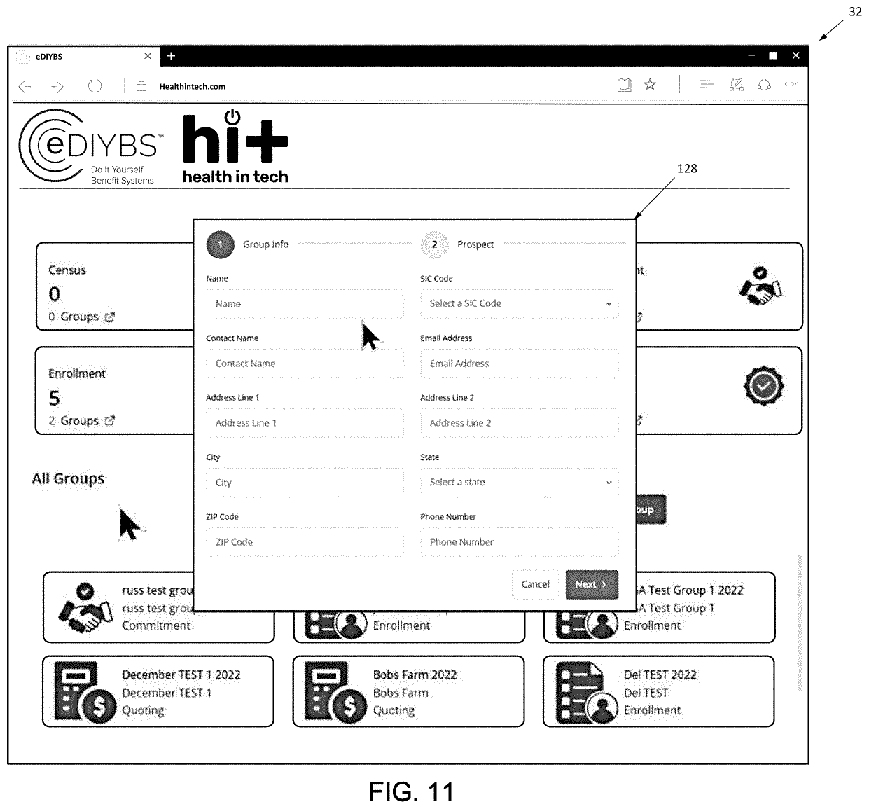

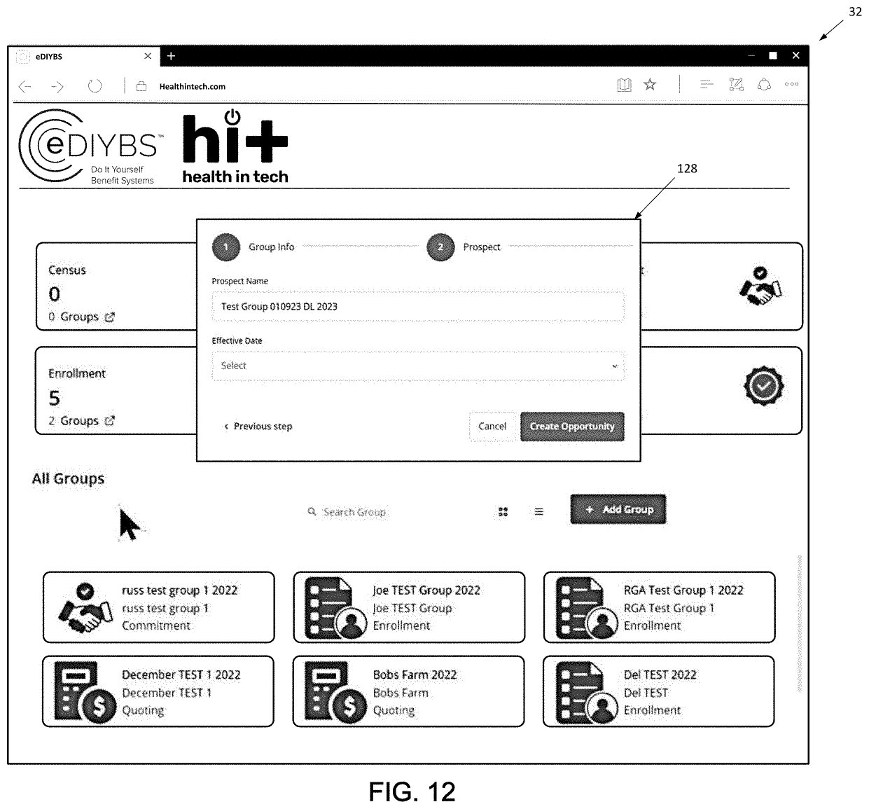

FIGS. 10-24 show screen shots of an example broker user interface 32, in accordance with one or more arrangements. FIG. 10 shows an example dashboard type interface for a broker user interface 32 to facilitate easy access and review of applications for group benefit system coverage. In this example application, the dashboard interface includes an upper panel 120 having number of tiles 122 summarizing data and providing links for accessing applications in various stages. In this example application, the upper panel 120 includes tiles 122 for applications in stages of: inputting census data, generating quotes, commitment, enrollment, implementation of enrolled policies, and live policies. In this example implementation, the tiles 122 indicate the number of applications in the applicable stage as well as the number of applicable groups. In this example application, the dashboard interface also includes a lower panel 124 having number of tiles 122 to facilitate easy review and access to status and applications submitted for various groups. However, the arrangements are not so limited. Rather, it is contemplated that in various arrangements, the dashboard interface may include any number of panels and/or tiles with various additional or alternative information to facilitate review and/or management of groups and/or applications. In the example arrangement shown, the dashboard type interface includes a button 126 to add a new group and begin a prospective application for group benefit system coverage. FIGS. 11 and 12 show an example user interface 128 that may be presented to facilitate creation of a new group and prospective application for group benefit system coverage, for example, when button 126 is pressed.

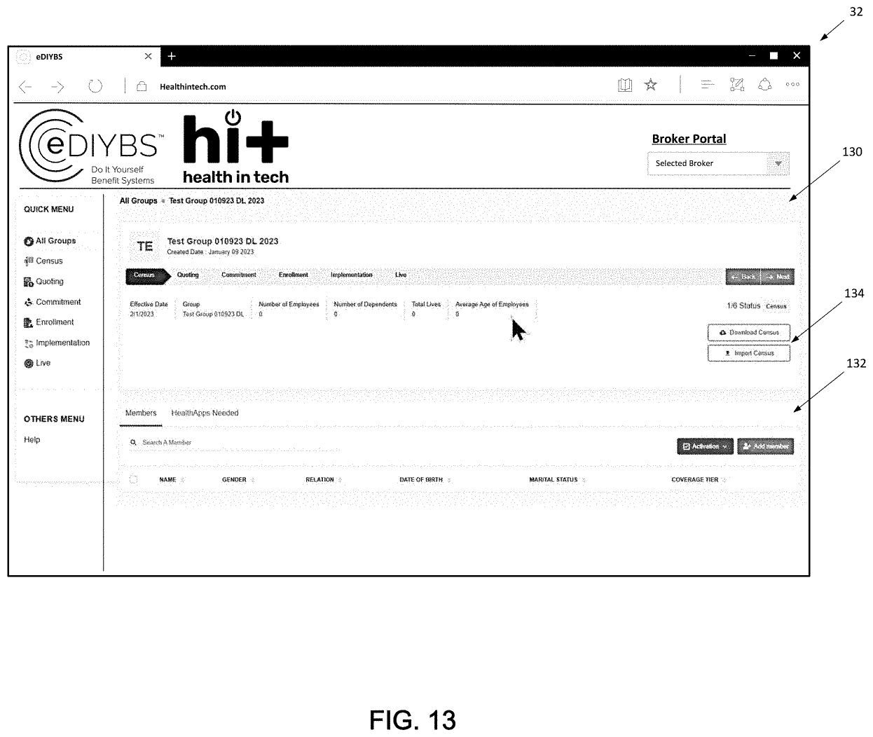

FIGS. 13-24 show an example user interface for a broker user interface 32 to facilitate review and management of a new/selected application for benefit system coverage for a created group at various stages of the application. In this example, the interface includes an upper panel 130 having a timeline interface configured to permit a user to review and configure an application at various stages (e.g., group census, quotation, commitment, enrollment, implementation, and/or live plan). In this example, the interface also includes a lower panel 132 configured to facilitate input and/or configuration of data/options for the application state selected in the upper panel 130.

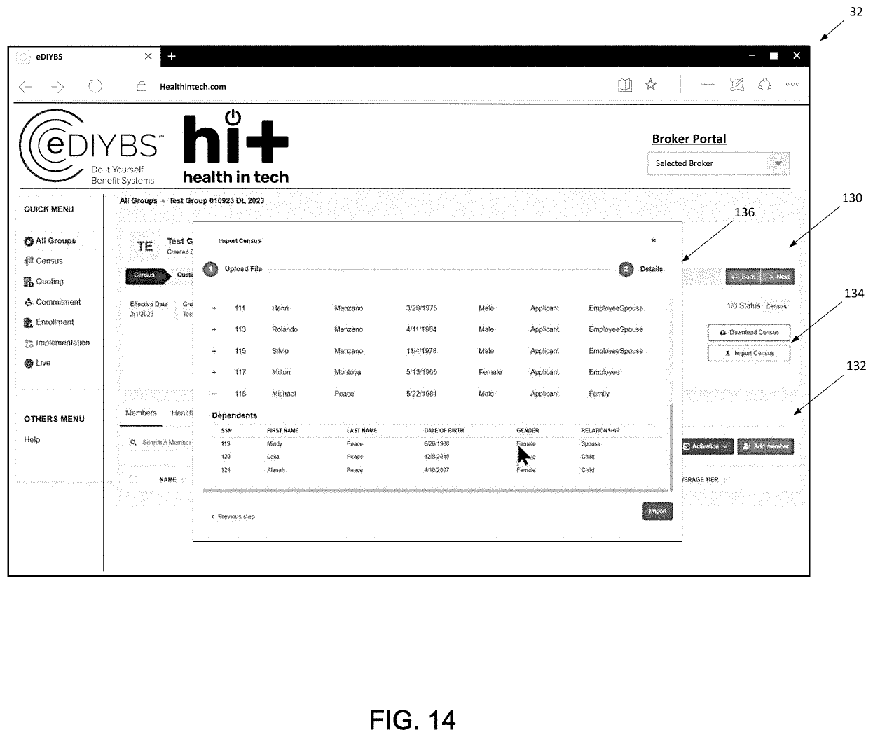

FIGS. 13-14 show the example user interface for a broker user interface 32 set for review and configuration of an application for a group in a first census stage. In this stage the interface is configured to permit a broker to specify members of the group. In this example arrangement, members may manually be added using the lower panel 132. Additionally or alternatively, in this example, upper panel 130 has buttons 134, which permit a broker to upload a census of members may be uploaded as a file (e.g., received from an employer) and/or download census of members for a group (e.g., from a previous policy or application). FIG. 14 shows an example user interface 136 that may be presented when buttons 134 are pressed to facilitate the import of census data for a group.

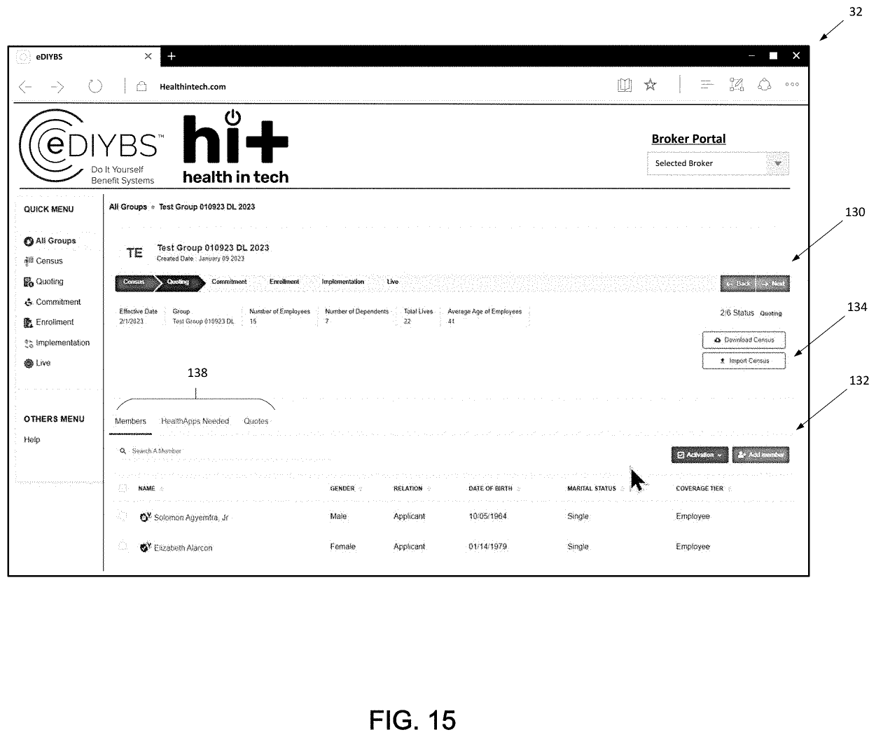

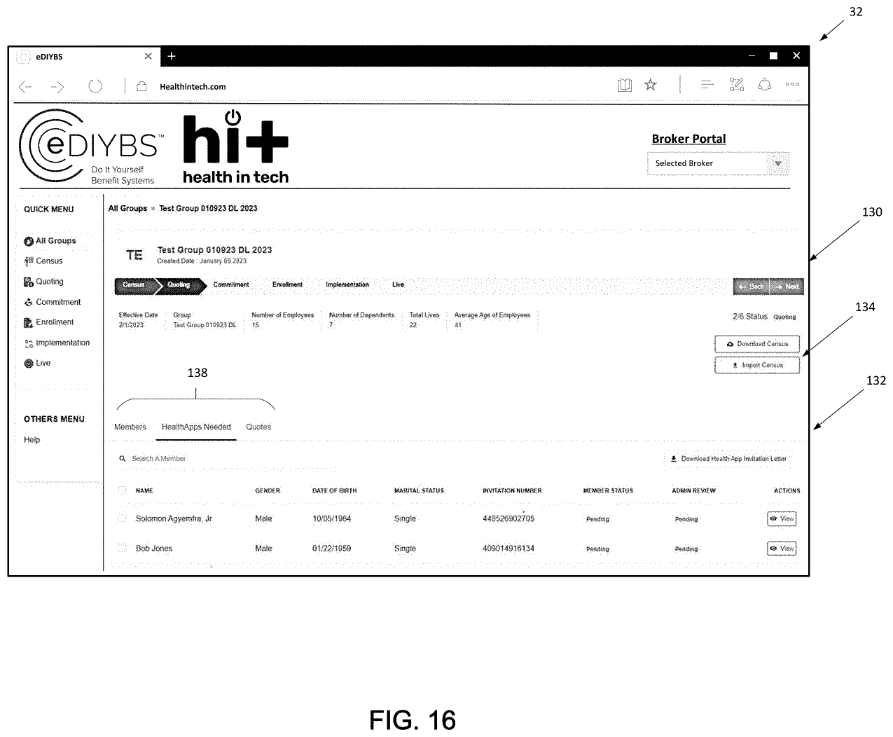

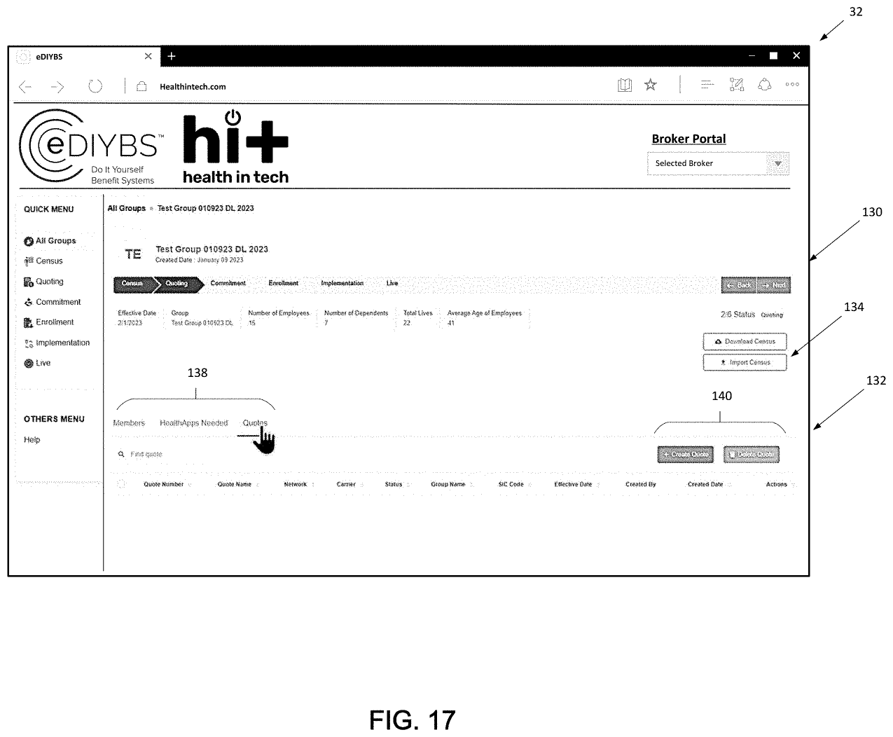

FIGS. 15-24 show the example user interface for a broker user interface 32 set for review and configuration of an application for a group in a second quoting stage after group members have been specified. In this stage, lower panel 132 provides tabs 138 for a user to review and/or configure group members, health application needed to acquire additional information for select group members, and quotes for benefit system coverage for the group. FIG. 15 shows the example user interface with a “Members” tab of the lower panel 132 selected. In this example, from the Members tab, a user may select and view/edit information for current members of the group. FIG. 16 shows the example user interface with a “HealthApps Needed” tab of the lower panel 132 selected. In this example, from the HealthApps Needed tab, the lower panel 132 displays members who have been identified by back end system 14 as high risk individuals from which additional information (e.g., in a health application) need to be received. FIG. 17 shows the example user interface with a “Quotes” tab of the lower panel 132 selected. In this example, from the Quotes tab, the lower panel 132 facilitates creation, review, and/or editing of quotes for the group. In this example, quotes may be create/deleted using buttons 140 in lower panel 132. In this example, new quotes may be added using button 140

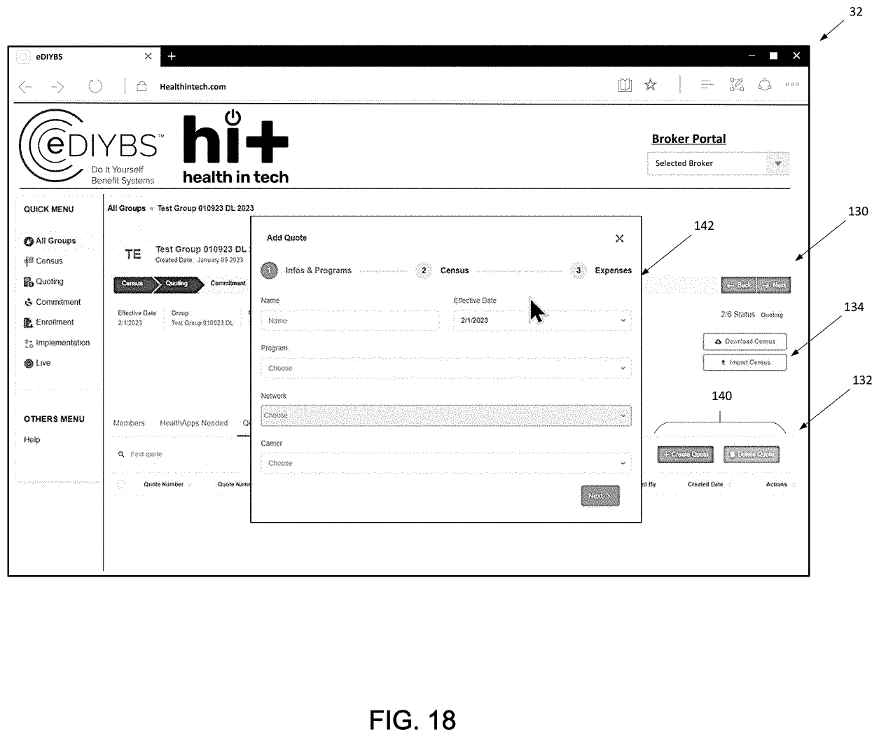

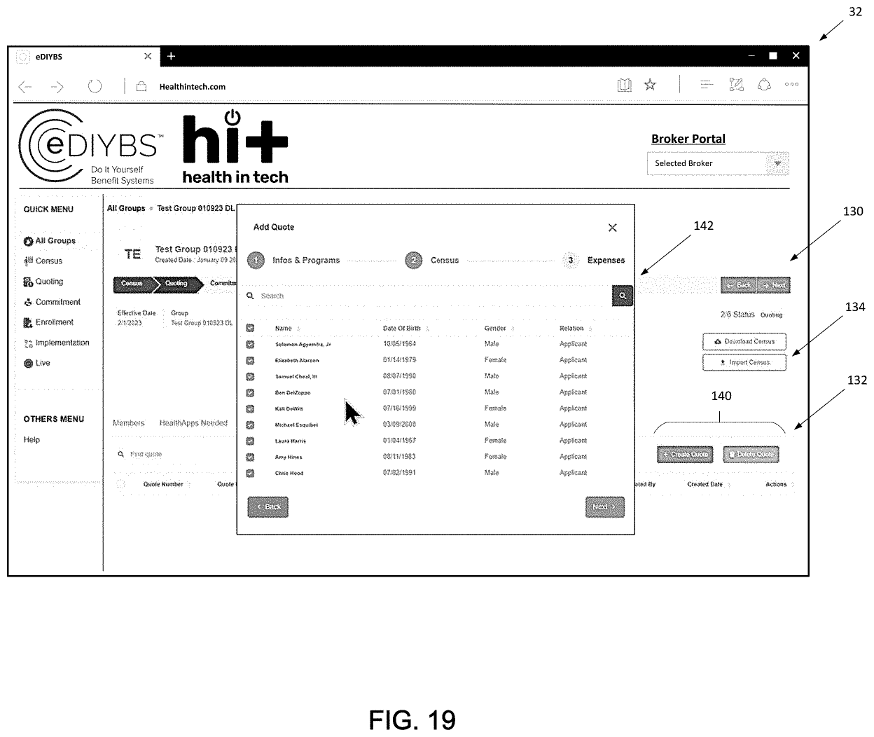

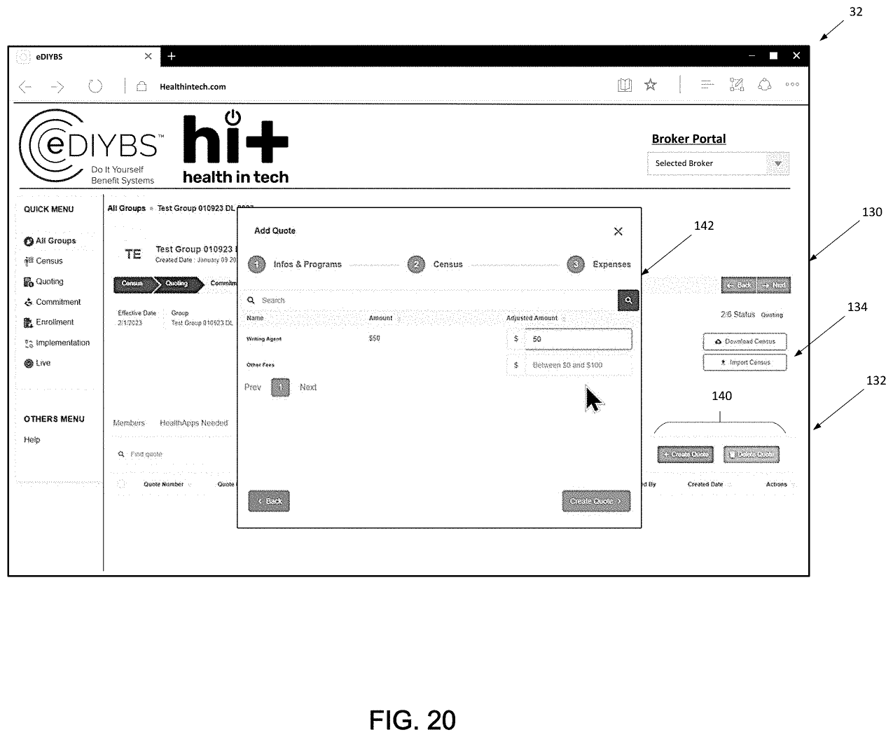

FIGS. 18-20 show broker user interface 32 with an example interface window 142 that is presented when “create quote” button 140 is pressed to facilitate creation of a new quote for the group. In this example, as shown in FIG. 18, the interface window 142 prompts a user to name the new quote and select effective date, and select desired program, provider network, and/or carrier for the desired benefit system coverage. Next, as shown in FIG. 19, the interface window 142 prompts the user to select members of the group to be covered by the quotation. In this example, all group members are selected by default but may be unselected to remove members from the quotation. Removing one or more members may be desirable, for example, if such members are high risk and have benefit system coverage through another source (e.g., covered under a spouse's policy). By removing such member, a broker may be able to lower the quoted rate for the remaining group of the employer. In this example, after members of the group to be covered are confirmed, the interface window 142 prompts the broker to specify additional adjustments/fees/expenses, as shown in FIG. 20.

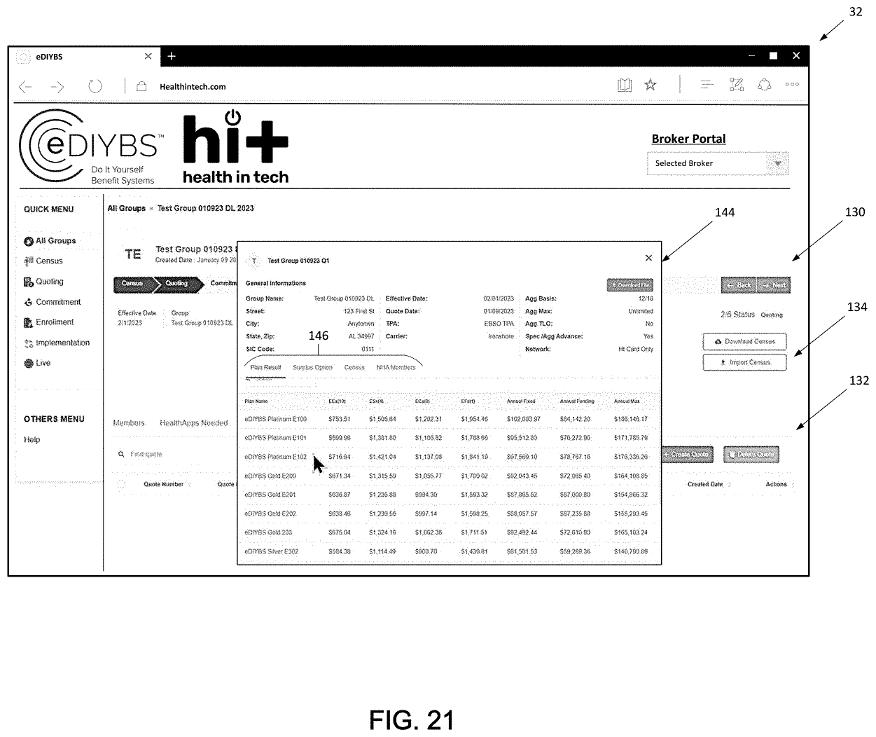

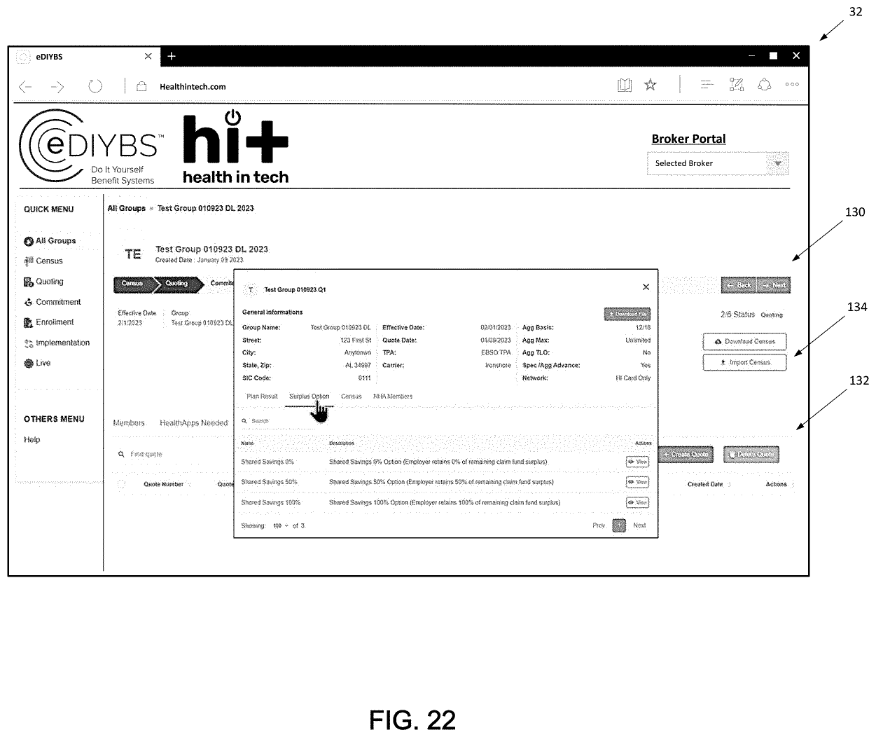

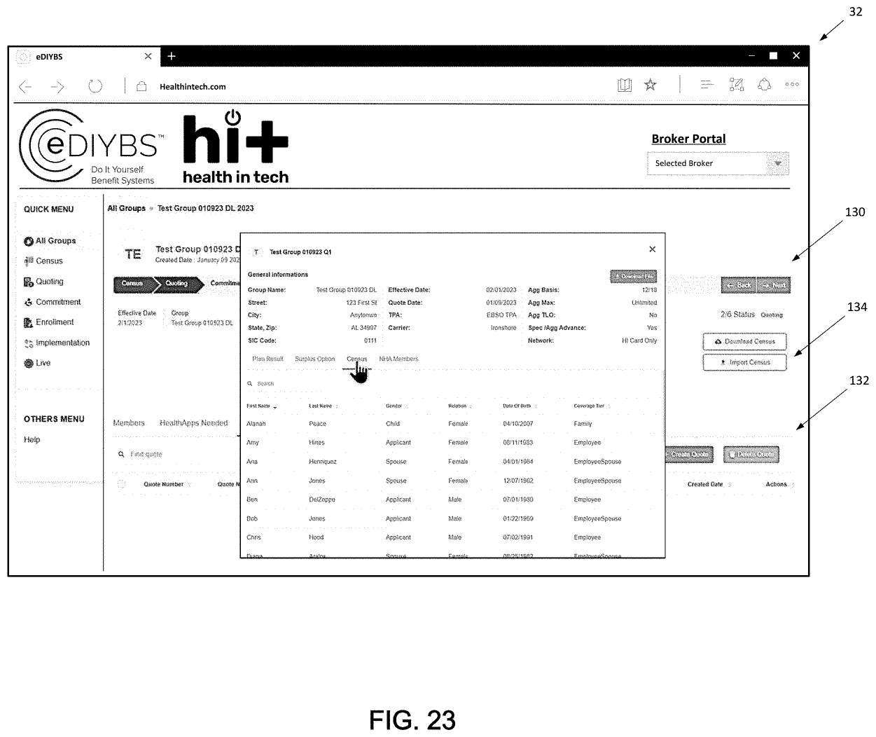

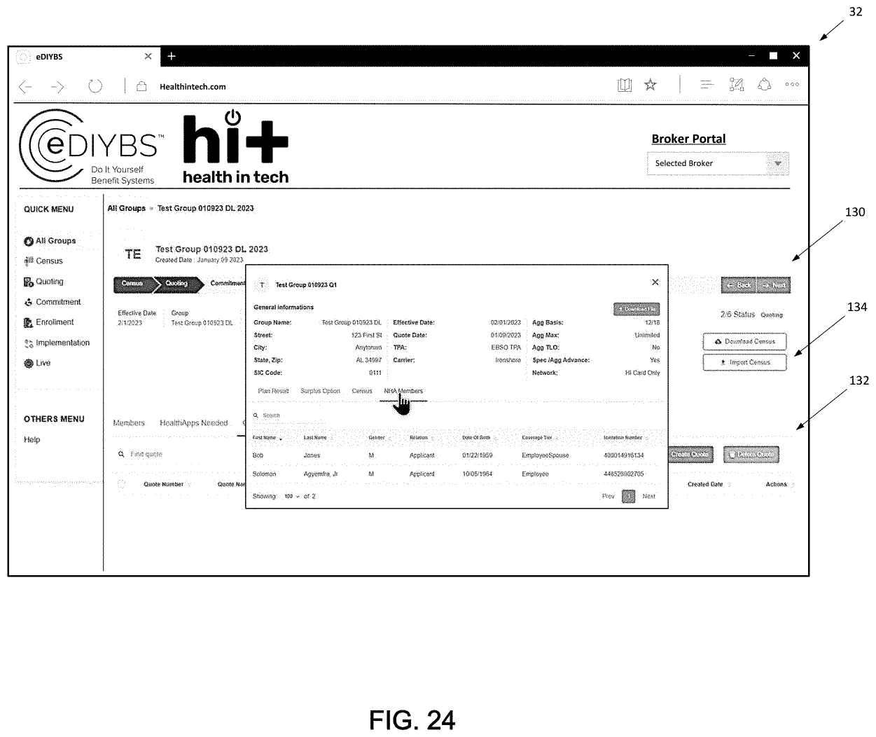

FIGS. 21-24 show broker user interface 32 with an example generated quote displayed in interface window 144. In this example, interface window 144 provides tabs 146 for a user to review and/or configure different aspects of the quote. In this example arrangement, as shown in FIG. 21, a “Plan Result” tab shows a listing of a plurality of different plans (e.g., bronze, silver, gold, platinum) included in the quote, with different set of coverage tiers. In this illustrative example, the quotation includes a plurality of different level funded coverage options, which are accessible via a “Surplus Option” tab in interface window 144. In this example arrangement, as shown in FIG. 22, the Surplus Option tab facilitates review and selection between different level funded coverage options. In this example, the quote includes options for return of 100% of surplus funds with no discount, 50% of surplus funds with a first discount, or 0% of surplus funds with a second larger discount. In this example arrangement, as shown in FIG. 23, a “Census” tab shows a listing of group members covered by the quote. In this example arrangement, as shown in FIG. 24, a “NHA” (i.e., no healthcare application) tab shows a listing of group members covered by the quote who need to submit a healthcare application (e.g., are required by carrier-specific underwriting criteria). In one or more arrangements, system 10 places the application in a continent status and does not permit the quotation to be finalized until all required healthcare applications have been submitted.

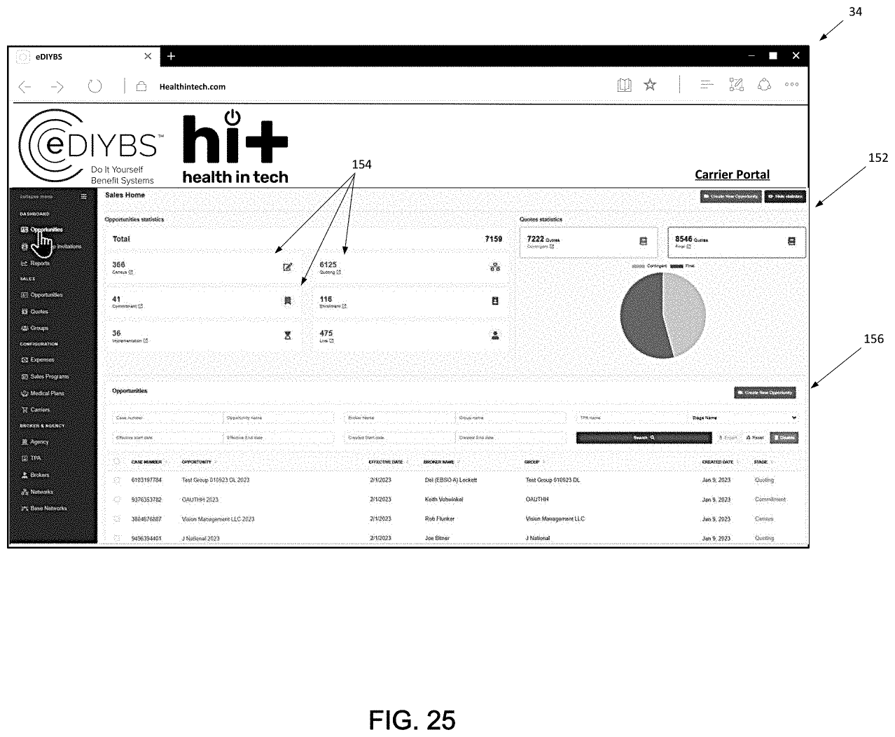

FIGS. 25-34 show screen shots of an example carrier user interface 34, in accordance with one or more arrangements. In the example arrangement shown, FIG. 25 shows an example dashboard type interface for a broker user interface 34 to facilitate easy access and review of applications for group benefit system coverage (e.g., by an underwriter). In this example application, the carrier user interface 34 includes an upper panel having number of tiles 154 summarizing data and providing links for accessing applications in various stages. In this example application, the upper panel 152 includes tiles 122 for applications in stages of: inputting census data, generating quotes, commitment, enrollment, implementation of enrolled policies, and live policies. In this example implementation, the tiles 122 indicate the number of applications in the applicable stage as well as the number of applicable groups. In this example application, the dashboard interface also includes a lower panel 156 having search interface for searching pending application. However, the arrangements are not so limited. Rather, it is contemplated that in various arrangements, the dashboard interface of carrier user interface 34 may include any number of panels and/or tiles with various additional or alternative information to facilitate review and/or management of groups and/or applications.

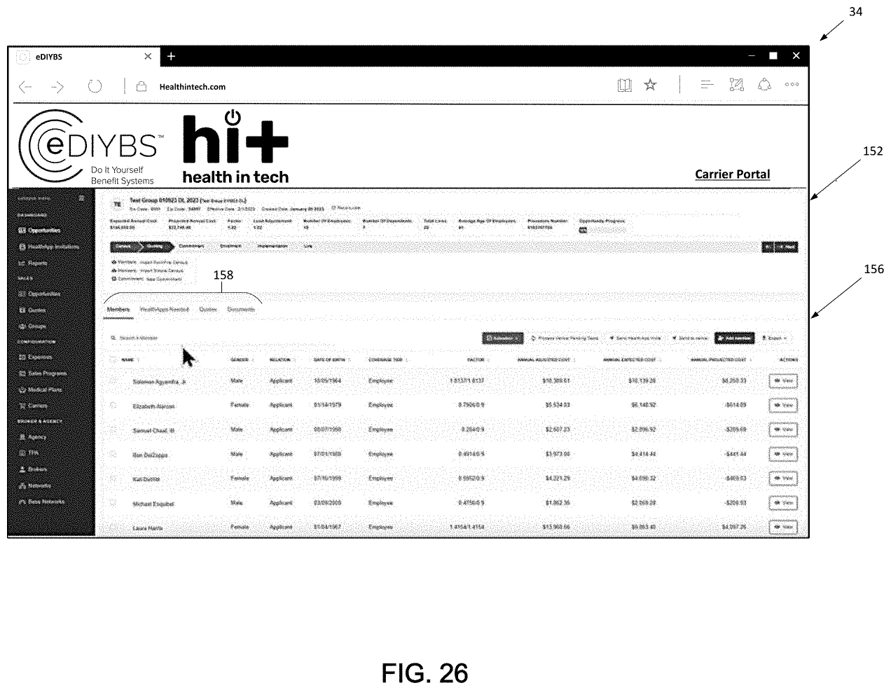

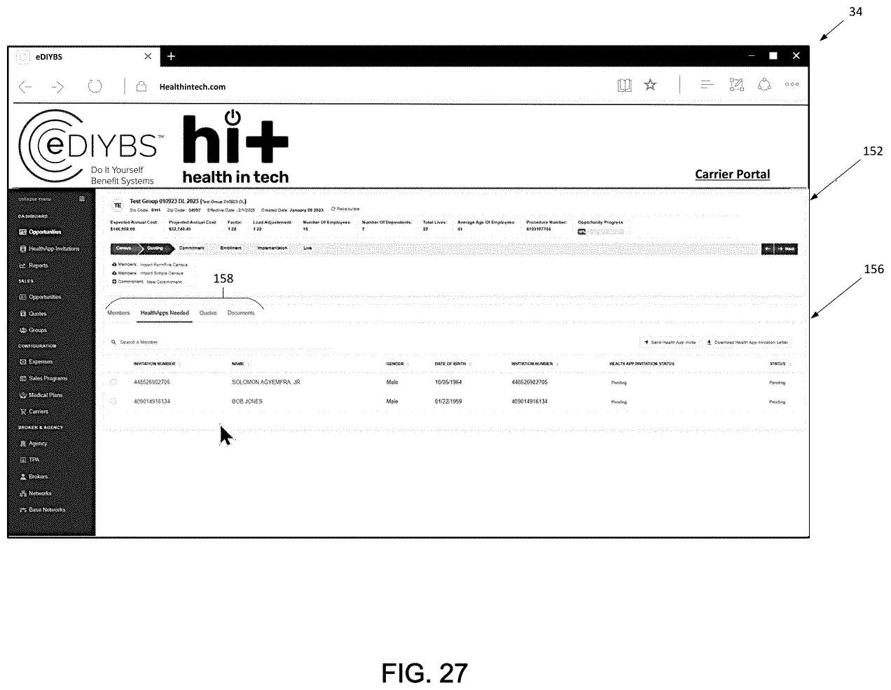

FIGS. 26-34 show the example user interface for a carrier user interface 34 set for review and configure of an application after a quote has been created (e.g., by a broker). In this stage, lower panel 156 provides tabs 158 for a carrier to review and/or configure group members, health application needed to acquire additional information for select group members, quotes, and documents for benefit system coverage for a selected group. FIG. 26 shows the example user interface with a “Members” tab of the lower panel 156 selected. In this example, from the Members tab, a user may select and view/edit information for current members of the group. FIG. 27 shows the example user interface with a “HealthApps Needed” tab of the lower panel 156 selected.

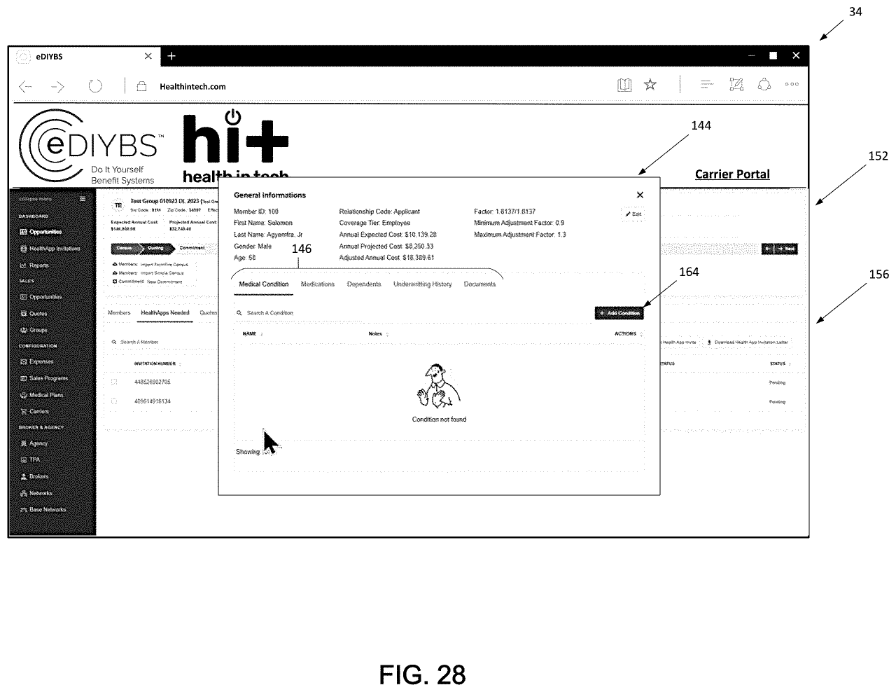

FIG. 28 shows an example carrier user interface 34 with an example interface window 144 configured to facilitate underwriting of a selected member of a group, in accordance with one or more arrangements. In this example, interface window 144 displays a summary of data projected costs/risks for the group member. In this example, the data summary shows projected costs that were estimated by the analytics system 24. In this example, the data summary also shows the determined risk assessment for the group member and automated risk adjustments factors that were applied to adjust risk of the group member.

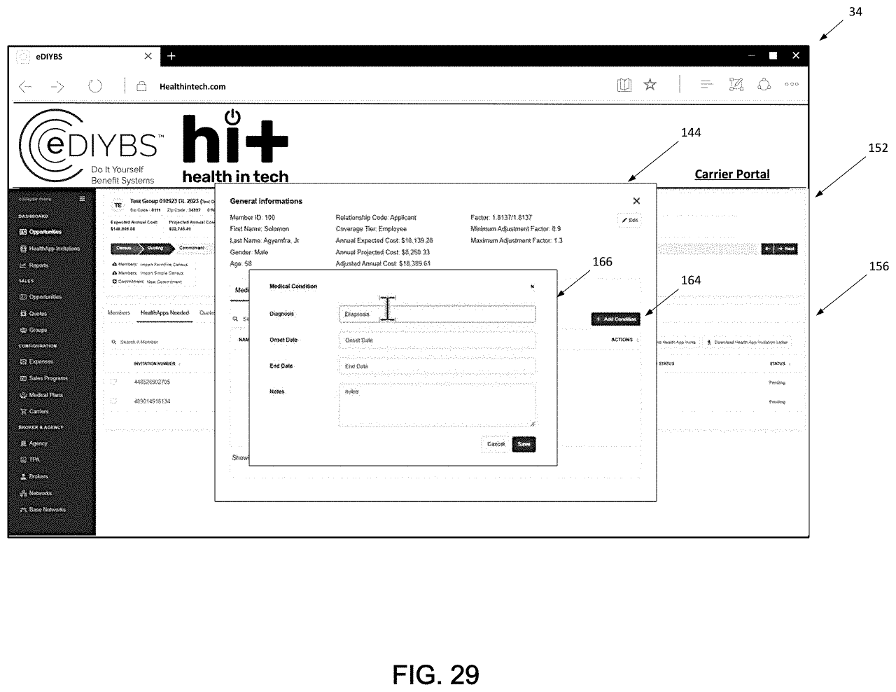

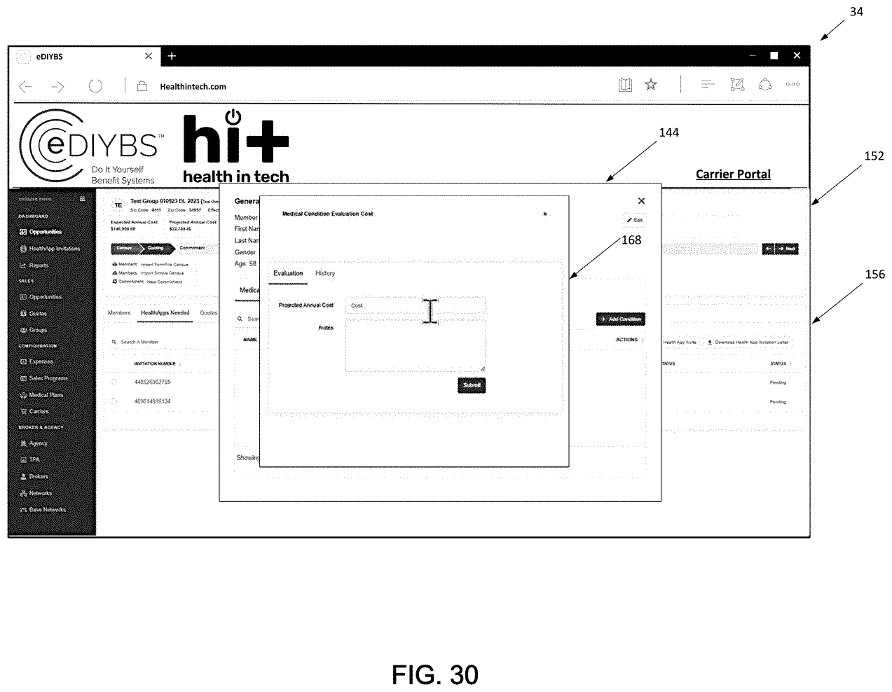

In this example, interface window 144 provides tabs 146 for a user to review and/or configure different aspects pertaining to underwriting of the selected group member. In this example arrangement, as shown in FIG. 28, a “Medical Condition” tab shows a listing of medical conditions that have been identified for the member. In this example the Medical Condition tab of interface window includes a button 164 to facilitate addition of medical conditions by an underwriter. FIG. 29 shows an example interface window 166, that is presented in response to user pressing button 164. The interface window 166 is configured to facilitate entry of medical conditions for a member. In this example, interface window 166 includes fields for a user to specify diagnosis, onset date, end-data, and other notes for a medical condition of the member. FIG. 30 shows an example interface window 168, that is presented in response to user pressing button 164, configured to facilitate evaluation of a selected medical condition of a member. In this example, interface window 168 includes fields for a user to specify a projected annual cost for the medical condition and other notes for a medical condition of the member. However, the arrangements are not so limited. Rather, it is contemplated that in various arrangements the interface windows may be configured to permit a user to enter various additional and/or alternative information.

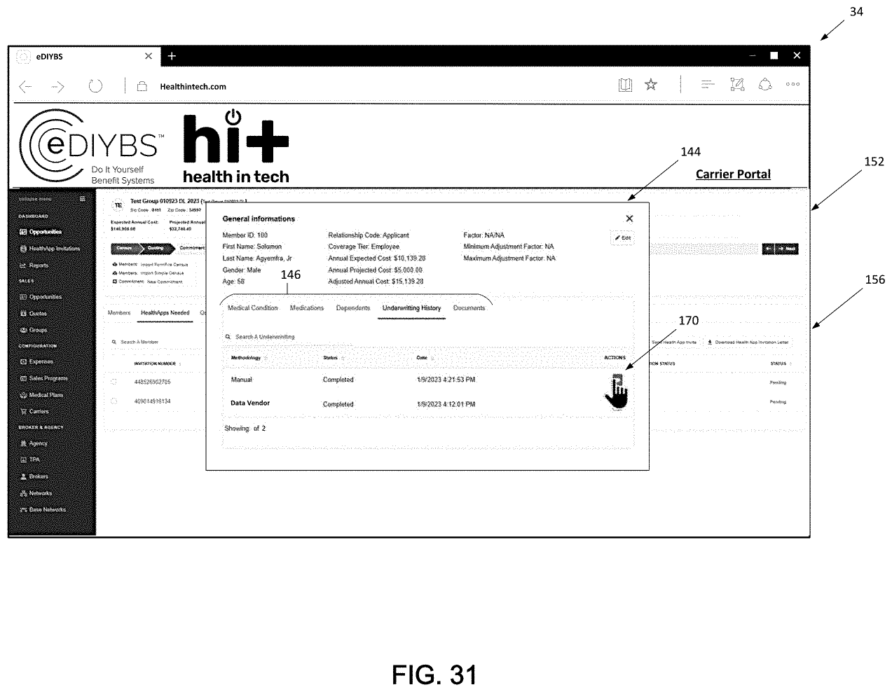

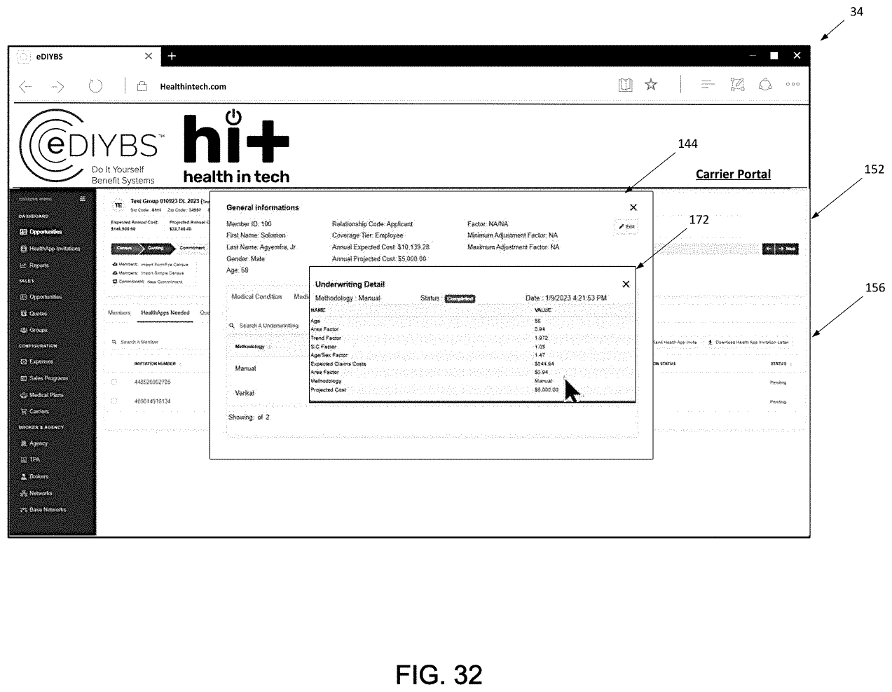

FIG. 31 shows an example of interface window 144 after updating cost for the medical condition(s) of the group member. In comparison to FIG. 28, projected costs for the group member have been manually reduced and risk assessment and risk factor adjustments have been overwritten. In this example arrangement, the “Underwriting History” tab is selected to show a history of underwriting assessments/adjustments for the group member. In this example arrangement, the underwriting history tab shows two underwriting events including: 1) an automated assessment retrieved by analytics system 24 from a third party data vendor 18 and 2) a manual adjustment performed by an underwriter. In this example arrangement, entries in the underwriting history tab include a button to review details of the underwriting event. FIG. 32 shows an example interface window 172, that is presented in response to user pressing button 170. The interface window 166 is configured to display details of the selected underwriting event.

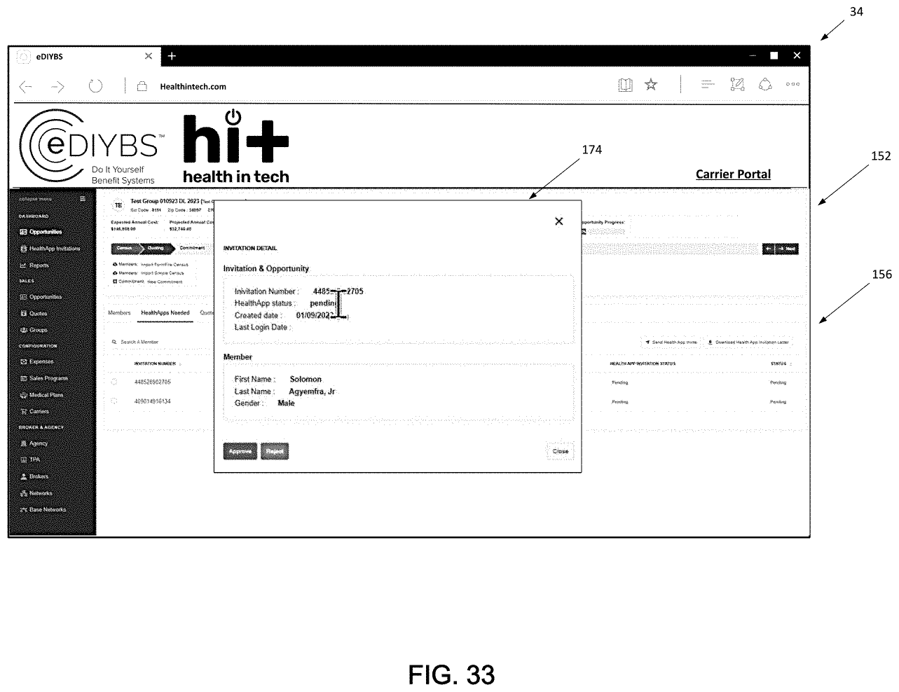

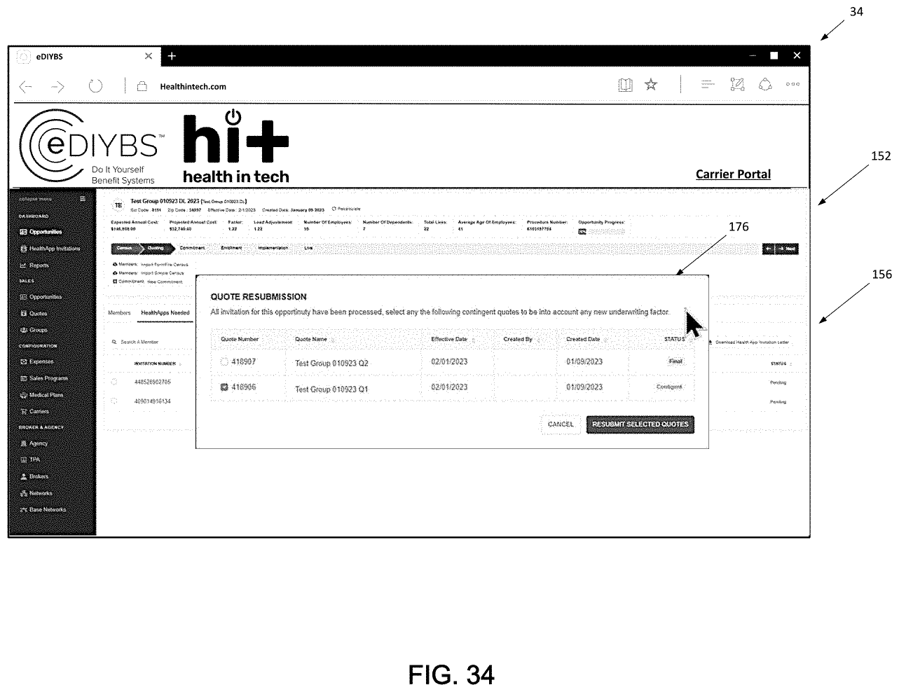

FIG. 33 shows an example interface window 174, that may be presented when an entry is selected form the HealthApps Needed tab. Using interface 174, a user may approve the health apps for the group members after underwriting has been completed. In one or more arrangements, after approval of the health apps for the group members, the underwriting system 26 automatically determines if there are any pending quotes for the members that may need updating and causes front end system 16 to prompt the user to select if they would like to update such quotes. FIG. 34 shows an example interface window 176 configured to prompt a user to select quotations to be updated.

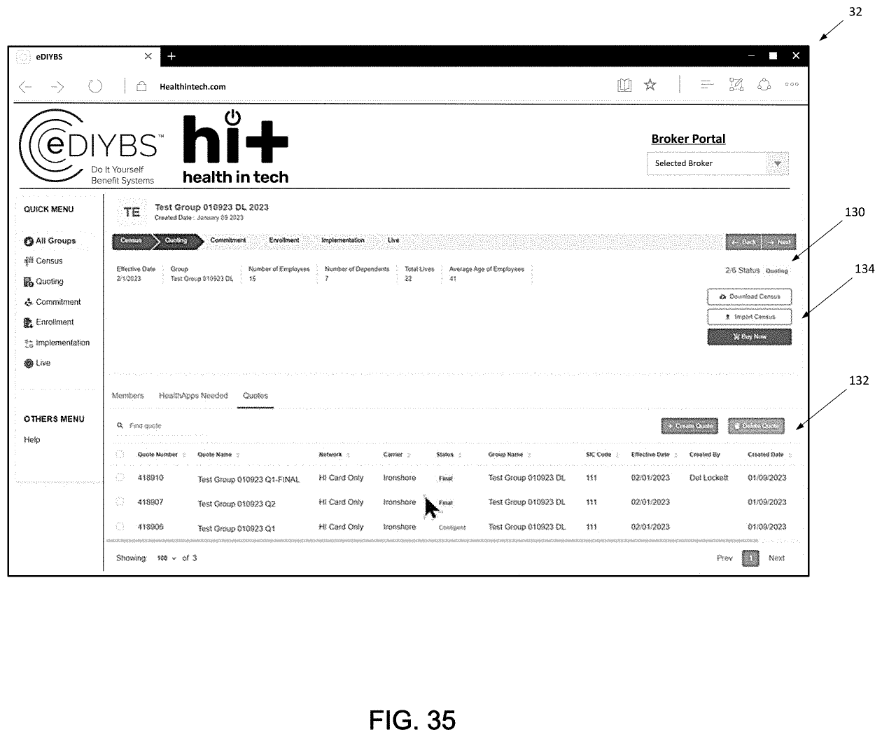

FIG. 35 shows an example of a broker user interface 32 updated following approval of health apps for all group members of a quote via carrier user interface 34. In this example, the broker user interface, shows status for the quote updated from continent to final. In this example, upon a quote being updated to final status, buttons 134 of broker user interface 32 provide an option to purchases the plan described in the finalized quote.

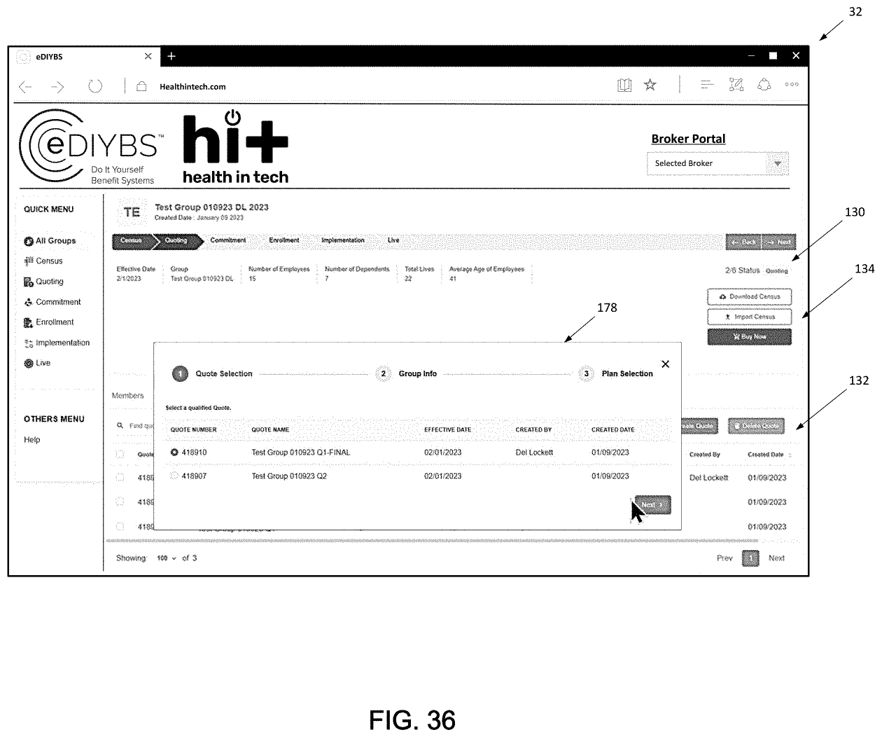

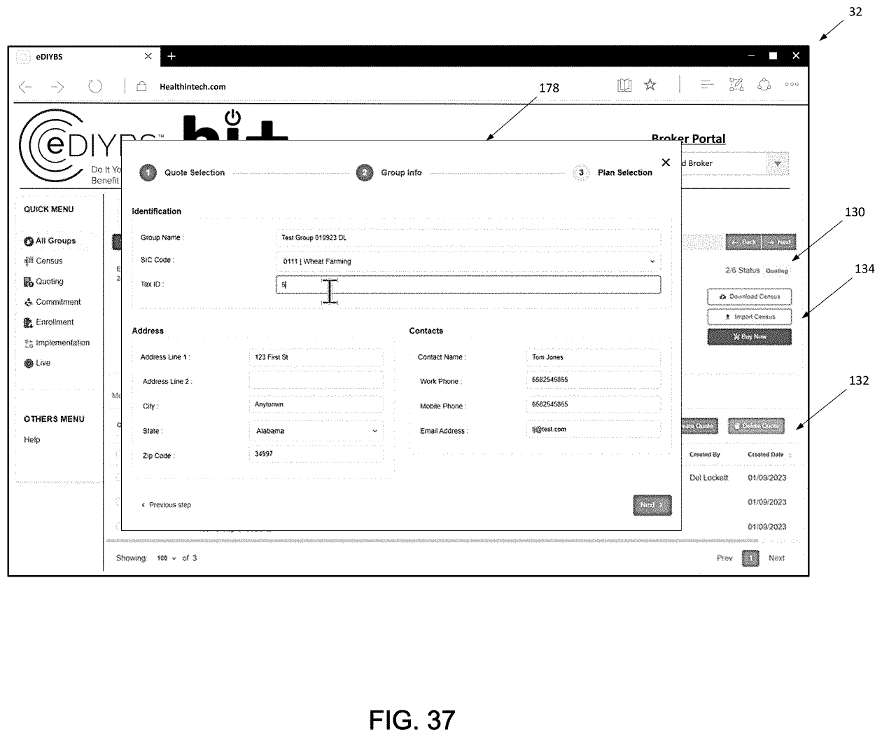

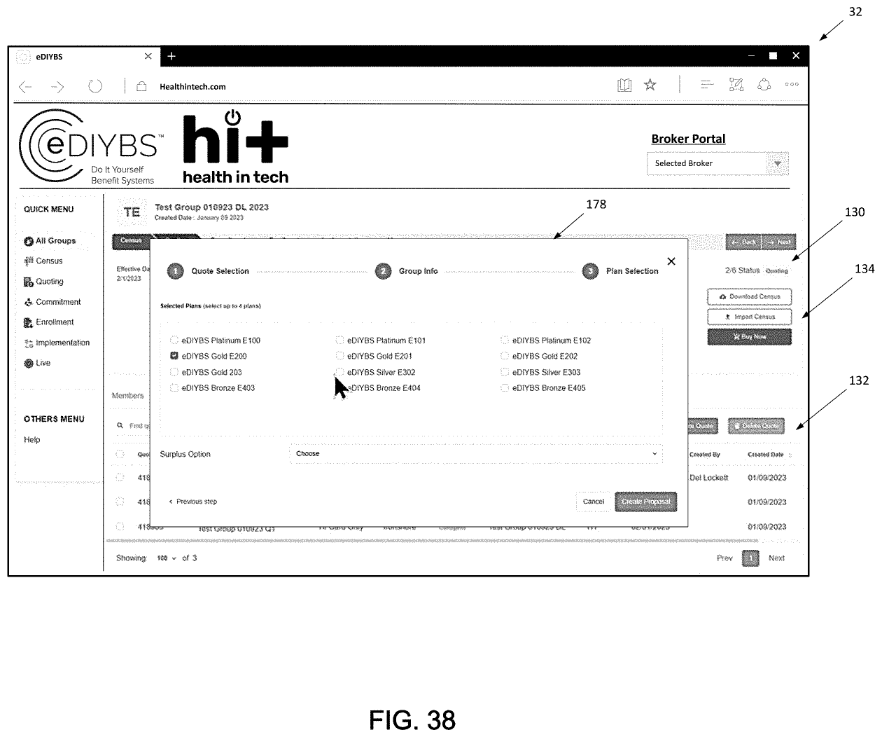

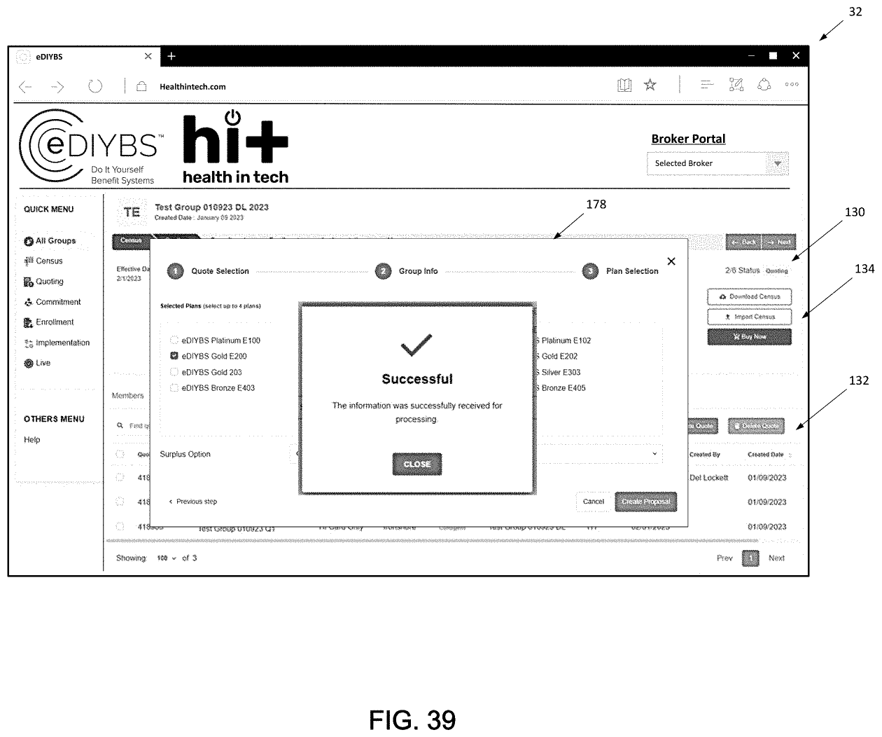

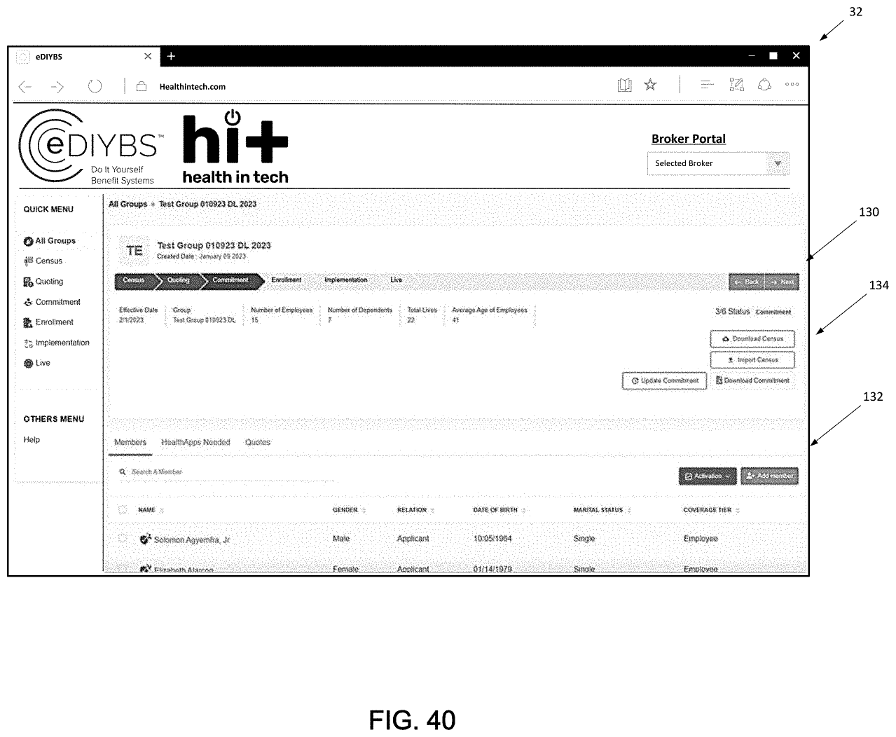

FIG. 36-39 show an example interface window 178 to facilitate purchase of a finalized quotation, in accordance with one or more arrangements. In this example, the interface window 178 is configured to walk the broker through selection of an available finalized quote, inputting and/or confirming details of the group, and selection of available plans to create a formal commitment proposal (a “commitment”) that can be provided to an employer (or other applicant for the group). In this example, as shown in FIG. 40, upon creation of the formal proposal, the timeline in upper panel 130 of broker user interface updates status to the commitment stage. In this stage, buttons 134 are updated to permit a broker to update and/or download the commitment.

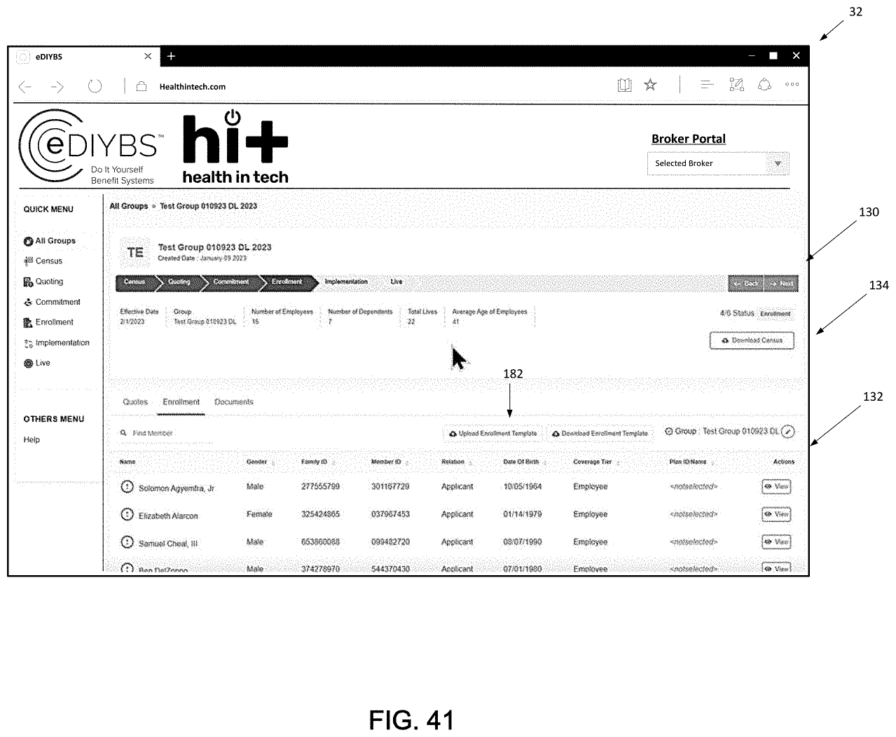

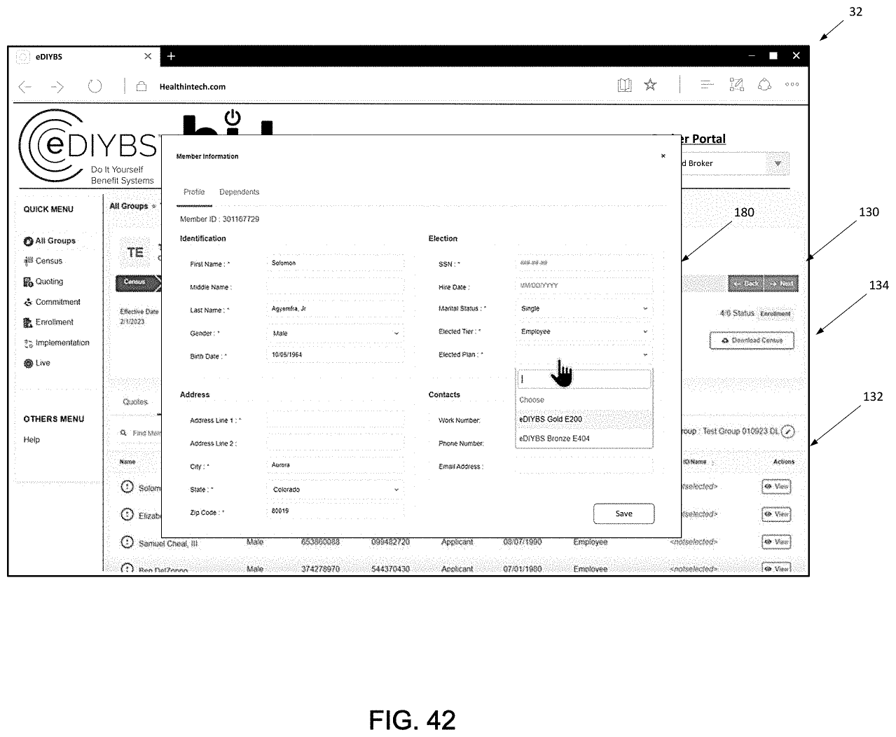

Once an employer confirms they wish to enroll, the broker may move the status of the application to the enrollment stage, as shown in FIG. 41. In the enrollment stage, broker may individually select members listed in lower panel 132 to view their information/status or enroll the member in a plan that they selected. FIG. 42 shows an example interface window 180 to facilitate enrollment of a group member in a selected plan, in accordance with one or more arrangements. Additionally or alternatively, in one or more arrangements, broker user interface 32 provides an interface (e.g., button 182) to permit a broker to upload an enrollment template submitted by an employer/group member. In response to an enrollment template being updated, underwriting system 26 is configured to automatically update enrollment status for members specified therein.

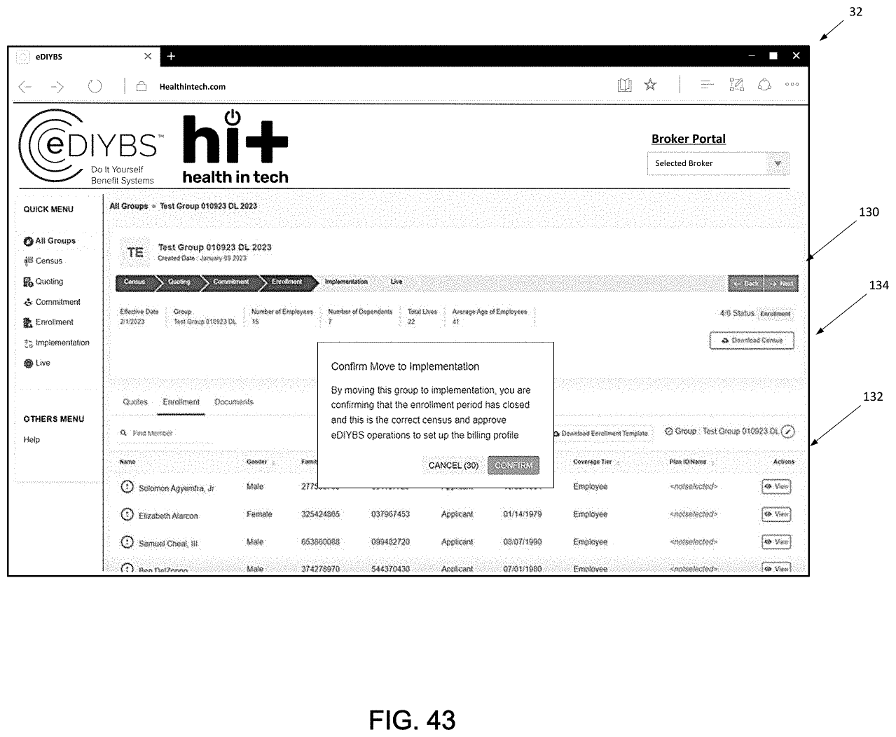

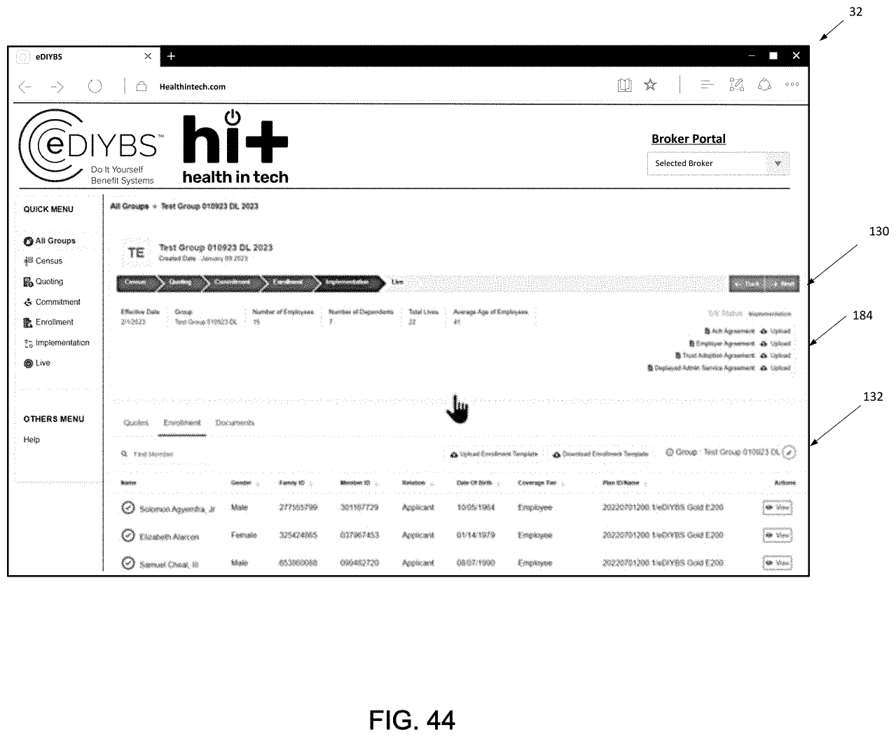

Once an applicable enrollment period has closed and enrollment information has been input for applicable group members, a broker may move the application to the implementation stage in broker user interface 32. As shown in FIG. 43, in one or more arrangements, broker user interface 32 prompt the broker to confirm that the enrolment period is closed, the census information for enrolled group members is correct, and the system may proceed to set up execution and billing for the group. In one or more arrangements, upon confirmation, underwriting system performs a number of automated processes to setup the benefit system policies for the group. In some various arrangements, such automated processes may include but are not limited to, for example, creation of legal documents to be signed, sending the documents to the brokers, employer, and/or group members for signature, and creation of an overview of plan details (a “sole case breakdown”) to be provided to a selected third party administrator for the policies for implementation, among other processes. FIG. 44 shows an example of broker user interface 32 in the implementation stage. In this stage, broker user interface 32 is updated with interface buttons 184 to permit the broker to upload signed plan documents received from the employer and/or enrollees.

In one or more arrangements, once executed legal documents have been uploaded and setup is confirmed with a third party administrator, the broker may more the application to the live stage using broker user interface 32.

### Data Processing System 200

Various blocks, modules, or other circuits of the back end system 14 and front end system 16 may be implemented to carry out one or more of the operations and activities described herein and/or shown in the figures. In these contexts, a “block” (also sometimes “logic circuit,” “control circuit,” “processing circuit,” “server,” “module,” “data processing system” or “system”) is a circuit specifically configured and arranged to carry out one or more of these or related operations/activities. For example, such circuits may be discreet logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, tablet, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain aspects are directed to a computer program product (e.g., nonvolatile memory device), which includes a machine or computer-readable medium having stored thereon instructions which may be executed by a computer (or other electronic device) to perform these operations/activities.

FIG. 44 shows an example data processing system 200 that may be used to implement systems, circuits, components, and/or processes of back end system 14 and front end systems 16, in accordance with one or more arrangements. Data processing system 200 is formed of any suitable size, shape, design, and/or technology and is configured to carry out the one or more of these or related operations/activities described herein. In the arrangement shown, as one example, data processing system 200 includes a processing circuit 202 and memory 204 having software code 206 or instructions that facilitates the processing and/or display of information, and a communication circuit 208, among other components.

Processing circuit 202 may be any computing device that receives and processes information and outputs commands according to software code 206 or instructions stored in memory 204. Memory 204 may be any form of information storage such as flash memory, ram memory, dram memory, a hard drive, or any other form of memory. Processing circuit 202 and memory 204 may be formed of a single combined unit. Alternatively, processing circuit 202 and memory 204 may be formed of separate but electrically connected components. Alternatively, processing circuit 202 and memory 204 may each be formed of multiple separate but electrically connected components.

Software code 206 or instructions is any form of information or rules that direct processing circuit 202 how to receive, interpret, and respond to information to operate as described herein. Software code 206 or instructions is stored in memory 204 and accessible to processing circuit 202. As an illustrative example, in one or more arrangements, software code or instructions may configure processing circuit 202 to interact with users via front end system 16 and perform various processes in response to user input.

Communication circuit 208 is formed of any suitable size, shape, design, and/or technology and is configured to facilitate communication with various other components of system 16 (as may be applicable). In one or more arrangements, as one example, communication circuit 208 includes a transceiver circuit and an antenna. A transceiver is any electronic device that facilitates two-way communication, that is, the delivery of information between data processing system 200 and other components of the system 10. An antenna is any device that is configured to receive wireless signals from over-the-air communication and/or transmit wireless signals in over-the-air communication. In an example arrangement, a transceiver of communication circuit 208 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 208 may be configured to communicate over a wired communication channel.

In various arrangements, communication circuit 208 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

Although in some arrangements, various circuits, components, systems, programs, or processes of back end system 14, front end system 16, or other portions of system 10 may be primary described or shown as being implemented together on the same system, machine, network, program or process, the arrangements are not so limited. Rather it is contemplated that such components, systems, programs, or processes of back end system 14, front end system 16 or other portions go system 10 may be implemented separately on by separate processes or programs and/or on separate circuits, systems, and/or components on the same bus or network or communicatively connected between different networks. Conversely, although in some arrangements, various circuits, components, systems, programs, or processes of back end system 14, front end system 16, or other portions of system 10 may be primary described or shown as being implemented separately, the arrangements are not so limited. Rather, it is contemplated that such components, systems, programs, or processes of back end system 14, front end system 16, and/or other portions of system 10 may be implemented together by the same processes or program and/or on the same circuit, system, and/or component of system 10.

From the above discussion it will be appreciated that the system 10 improves upon the state of the art. For example, some various embodiments provide an improved system for submission and/or underwriting of benefit system coverage applications: that is efficient, that is cost effective, that utilizes more detailed medical data to provide improved accuracy, that identifies high risk individuals for more detailed assessment, that is automated, that is scalable, that can be used for large and small group policies, that saves time, that is easy and intuitive to use, and/or that improves a user experience.

It will be appreciated by those skilled in the art that other various modifications could be made to the device without parting from the spirit and scope of this disclosure. All such modifications and changes fall within the scope of the claims and are intended to be covered thereby.

What is claimed:

1. A system, comprising:
a front end system;
a back end system;
the back end system communicatively connected to the front end system;
wherein the front end system is configured to provide a first user interface for a broker to submit an application for coverage of a group for a plurality of benefit coverage plans selected by the broker;
wherein the group includes a plurality of individuals;
wherein the back end system is configured to automatically evaluate risk for the plurality of individuals and determine rates for the plurality of benefit coverage plans for the group by:
determining a base rate for a first one of the plurality of benefit coverage plans;
retrieving a modifier for a second one of the plurality of benefit coverage plans; and
determining a rate for the second one of the plurality of benefit coverage plans by multiplying the base rate by the modifier.

2. The system of claim 1, wherein the back end system is communicatively connected to one or more data vendor systems;
wherein the back end system is configured to retrieve additional data on one or more of the plurality of individuals in the group from the one or more data vendor systems.

3. The system of claim 1, wherein the back end system is communicatively connected to one or more data vendor systems;
wherein the back end system is configured to retrieve additional data on one or more of the plurality of individuals in the group from the one or more data vendor systems;
wherein the additional data identifies prescriptions and high risk medical conditions of the group.

4. The system of claim 1, wherein the back end system is communicatively connected to one or more data vendor systems;
wherein the back end system is configured to retrieve additional data on one or more of the plurality of individuals in the group from the one or more data vendor systems;
wherein the additional data identifies high risk individuals of the group.

5. The system of claim 1, wherein the back end system is configured to identify a subset of high risk individuals of the group and request the subset of high risk individuals to submit additional medical information.

6. The system of claim 1, wherein in determining a base rate for a first one of the plurality of benefit coverage plans the back end system:
determines a respective risk for each of the plurality of individuals of the group; and
determines an overall risk for the group based on the respective risks for the plurality of individuals for the group.

7. The system of claim 1, wherein in determining a base rate for a first one of the plurality of benefit coverage plans the back end system:
determines a respective risk for each of the plurality of individuals of the group; and
requests additional information from one of more of the plurality of individuals of the group for which the respective risk exceeds a threshold;
updates the determined risks for the one of more of the plurality of individuals in response to receiving the additional information from the one of more of the plurality of individuals; and
determines an overall risk for the group based on the respective risks for the plurality of individuals for the group.

8. The system of claim 1, wherein the back end system includes an analytics system configured to derive additional data on one or more of the plurality of individuals in the group.

9. The system of claim 1, wherein the front end system is configured to provide second user interface for a carrier to review and underwrite the application for coverage of the group under the plurality of benefit coverage plans.

10. A system, comprising:
a front end system;
a back end system;
the back end system communicatively connected to the front end system;
wherein the front end system is configured to provide a first user interface for a broker to:
select one or more benefit coverage plans from a set of benefit coverage plans offered by a plurality of carriers; and
submit an application for coverage of a group under one or more benefit coverage plans;
wherein the group includes a plurality of individuals;
wherein the back end system is configured to store respective sets of carrier specific underwriting criteria for the plurality of carriers;
wherein the back end system is configured to identify which carrier of the plurality of carriers offers the one or more benefit coverage plans and retrieve the respective set of carrier specific underwriting criteria for the identified carrier;
wherein the back end system is configured to automatically evaluate risk for the plurality of individuals and determine rates for the one or more benefit coverage plans for the group according to the carrier specific underwriting criteria for the identified carrier.

11. The system of claim 10, wherein the back end system is configured to identify a subset of high risk individuals of the group according to the carrier specific underwriting criteria;
wherein the back end system is configured to request the subset of high risk individuals to submit additional medical information;
wherein the back end system is configured to determine rates for the one or more benefit coverage plans for the group as a function of the additional medical information.

12. The system of claim 10, wherein the back end system is configured to determine a respective first risk score for the plurality of individuals of the group using an automated process;
wherein the back end system is configured to identify a subset of individuals of the group according to the carrier specific underwriting criteria for determination of a respective second risk score by one or more underwriters;
wherein the back end system is configured to determine rates for the one or more benefit coverage plans for the group as a function of the first risk scores and the second risk scores.

13. The system of claim 10, wherein the back end system is configured to determine a respective first risk score for the plurality of individuals of the group using an automated process;
wherein the back end system is configured to adjust the determined first risk scores for the plurality of individuals according to the carrier specific underwriting criteria to produce respective second risk scores for the plurality of individuals;
wherein the back end system is configured to determine rates for the one or more benefit coverage plans for the group as a function of the second risk scores for the plurality of individuals.

14. The system of claim 10, wherein the back end system is configured to determine a respective first risk score for the plurality of individuals of the group using an automated process;
wherein the back end system is configured to adjust the determined first risk scores for the plurality of individuals according to a minimum risk score and a maximum risk score specified in the carrier specific underwriting criteria to produce respective second risk scores for the plurality of individuals;
wherein the back end system is configured to determine rates for the one or more benefit coverage plans for the group as a function of the second risk scores for the plurality of individuals.

15. The system of claim 10, wherein the back end system is communicatively connected to one or more data vendor systems;
wherein the back end system is configured to retrieve additional data on one or more of the plurality of individuals in the group from the one or more data vendor systems.

16. The system of claim 10, wherein the back end system is communicatively connected to one or more data vendor systems;
wherein the back end system is configured to retrieve additional data on one or more of the plurality of individuals in the group from the one or more data vendor systems;
wherein the additional data identifies prescriptions and high risk medical conditions of the group.

17. The system of claim 10, wherein the back end system is communicatively connected to one or more data vendor systems;
wherein the back end system is configured to retrieve additional data on one or more of the plurality of individuals in the group from the one or more data vendor systems;
wherein the additional data identifies high risk individuals of the group.

18. The system of claim 10, wherein the back end system includes an analytics system configured to derive additional data on one or more of the plurality of individuals in the group.

19. The system of claim 10, wherein the front end system is configured to provide second user interface for a carrier to review and underwrite the application for coverage of the group under the one or more benefit coverage plans.

20. A system, comprising:
a front end system;
a back end system;
the back end system communicatively connected to the front end system;
wherein the front end system is configured to provide a first user interface for a broker to submit an application for coverage of a group under one or more benefit coverage plans;
wherein the group includes a plurality of individuals;
wherein the back end system is configured to automatically evaluate information included in the application for the plurality of individuals and determine rates for the one or more benefit coverage plans for the group.

21. The system of claim 20, wherein the back end system is communicatively connected to one or more data vendor systems;
wherein the back end system is configured to retrieve additional data on one or more of the plurality of individuals in the group from the one or more data vendor systems.

22. The system of claim 20, wherein the back end system is communicatively connected to one or more data vendor systems;
wherein the back end system is configured to retrieve additional data on one or more of the plurality of individuals in the group from the one or more data vendor systems;
wherein the additional data identifies prescriptions and high risk medical conditions of the group.

23. The system of claim 20, wherein the back end system is communicatively connected to one or more data vendor systems;
wherein the back end system is configured to retrieve additional data on one or more of the plurality of individuals in the group from the one or more data vendor systems;
wherein the additional data identifies high risk individuals of the group.

24. The system of claim 20, wherein the back end system is configured to identify a subset of high risk individuals of the group and request the subset of high risk individuals to submit additional medical information.

25. The system of claim 20, wherein the back end system includes an analytics system configured to derive additional data on one or more of the plurality of individuals in the group.

26. The system of claim 20, wherein the back end system is configured to determine rates for a plurality of benefit coverage plans for the group by:
determining a base rate for a first one of the plurality of benefit coverage plans;
retrieving a modifier for a second one of the plurality of benefit coverage plans; and
determining a rate for the second one of the plurality of benefit coverage plans by multiplying the based rate by the modifier.

27. The system of claim 20, wherein the front end system is configured to provide second user interface for a carrier to review and underwrite the application for coverage of the group under the one or more benefit coverage plans.

28. The system of claim 20, wherein the back end system is configured to provide second user interface for a carrier to perform underwriting of the application.
